(19) United States
(12) Patent Application Publication
(10) Pub. No.: US 2025/0356179 A1
(43) Pub. Date: Nov. 20, 2025

(54) HARDWARE EMBEDDED NEURAL NETWORK MODEL AND WEIGHTS FOR EFFICIENT INFERENCE

(71) Applicant: Intel Corporation, Santa Clara, CA (US)

(72) Inventors: Yaron Klein, Rosh Haayin (IL); Yuval Vered, Tel-Aviv (IL); John Crouter, Fair Oaks, CA (US); Stanislav Borisover, Haifa (IL)

(73) Assignee: Intel Corporation, Santa Clara, CA (US)

(21) Appl. No.: 19/281,006

(22) Filed: Jul. 25, 2025

Related U.S. Application Data
(63) Continuation of application No. PCT/US2025/027903, filed on May 6, 2025.
(60) Provisional application No. 63/652,558, filed on May 28, 2024.

(51) Int. Cl. G06N 3/063; G06N 3/045; G06N 3/048

(52) U.S. Cl. CPC G06N 3/063; G06N 3/045; G06N 3/048

(57) ABSTRACT

A “models-on-silicon” chip can encapsulate Large Language Model weights and inference architecture directly onto the hardware by etching the weights onto the chip and implementing custom circuits to perform operations of a Large Language Model. The weights are stored in sequential read-only memory, and the operations are orchestrated in a feedforward manner. Each line is read at a designated time slot along with the operation that is operating on the data. The architecture eliminates the recurring task of loading weights and the model processing graph onto Graphics Processing Units each time. Moreover, the architecture frees up the need to persistently retrieve weights from memory for each computation, and the data is stored near the circuits performing the operations. Performance is improved, routing is simplified, and data is more quickly accessed. The architecture is cost-effective and can be highly scalable.

### CROSS-REFERENCE TO RELATED APPLICATION(S)

This application is a bypass continuation under 35 U.S.C. 111(a) and claims priority to and/or receives benefit from International Application No. PCT/US2025/027903, filed on 6 May 2025 and titled “HARDWARE EMBEDDED NEURAL NETWORK MODEL AND WEIGHTS FOR EFFICIENT INFERENCE”. The International Application claims priority to and/or receives benefit from U.S. Provisional Application No. 63/652,558, filed on 28 May 2024 and titled “HARDWARE EMBEDDED NEURAL NETWORK MODEL AND WEIGHTS FOR EFFICIENT INFERENCE”. The International PCT Application and US Provisional Application are hereby incorporated by reference in their entirety.

### BACKGROUND

Deep neural networks (DNNs) are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an exemplary chip architecture, according to some embodiments of the disclosure.

FIG. 2 illustrates exemplary details within the parts of the exemplary chip architecture, according to some embodiments of the disclosure.

FIG. 3 illustrates embedding an exemplary open-source model onto the chip, according to some embodiments of the disclosure.

FIG. 4 illustrates exemplary hardware blocks representing an exemplary open-source model, according to some embodiments of the disclosure.

FIG. 5 illustrates a sequential read-only memory, according to some embodiments of the disclosure.

FIG. 6 illustrates a sequential read/write memory in an attention multiplier circuit, according to some embodiments of the disclosure.

FIG. 7A illustrates an exponent unit circuit, according to some embodiments of the disclosure.

FIG. 7B illustrates an exponent function, according to some embodiments of the disclosure.

FIG. 8A illustrates a sigmoid linear unit (SILU) activator circuit, according to some embodiments of the disclosure.

FIG. 8B illustrates a sigmoid linear unit function and a rectified linear unit (RELU) function, according to some embodiments of the disclosure.

FIG. 9 illustrates a weights multiplier circuit, according to some embodiments of the disclosure.

FIG. 10 illustrates an embedding dot unit circuit, according to some embodiments of the disclosure.

FIG. 11 illustrates bit cell area optimization, according to some embodiments of the disclosure.

FIG. 12 illustrates a weights multiplier circuit, according to some embodiments of the disclosure.

FIG. 13 illustrates a SoftMax circuit, according to some embodiments of the disclosure.

FIG. 14 illustrates an embedder circuit, according to some embodiments of the disclosure.

FIG. 15 illustrates a root mean square (RMS) normalizer circuit, according to some embodiments of the disclosure.

FIG. 16 illustrates a sampler circuit, according to some embodiments of the disclosure.

FIG. 17 illustrates a sampling comparator circuit, according to some embodiments of the disclosure.

FIG. 18A illustrates a rotary positional encoding circuit, according to some embodiments of the disclosure.

FIG. 18B illustrates a cosine function and a sine function, according to some embodiments of the disclosure.

FIG. 19A illustrates using multiple chips to implement a large transformer model, according to some embodiments of the disclosure.

FIG. 19B illustrates using multiple chips to implement a large transformer model, according to some embodiments of the disclosure.

FIG. 20 illustrates hardware-based inferencing process with embedded Large Language Model (LLM) model and read-only memory (ROM), according to some embodiments of the disclosure.

FIG. 21 illustrates a matrix multiplication operation, according to some embodiments of the disclosure.

FIG. 22 illustrates an embedded weights fused multiply-add architecture, according to some embodiments of the disclosure.

FIG. 23 is a flow diagram illustrating a method for performing inference on a models-on-silicon chip, according to some embodiments of the disclosure.

FIG. 24 is a block diagram of an exemplary computing device, according to some embodiments of the disclosure.

### DETAILED DESCRIPTION

### Technical Problem

The problem being solved is the need for a cost-effective, dedicated solution for artificial intelligence (AI) inference tasks. Huge AI models are capable of addressing any small-scale need (for example, audio to text, robotics, or the like). These huge models are expensive in power and performance and are therefore limited in terms of implementation. For example, a humanoid system may use a huge battery to perform simple tasks, and real-time response time can be difficult or close to impossible to achieve. Such systems may also require Internet connectivity to a cloud computing environment that implements the huge model and thus cannot autonomously execute in an isolated environment. Huge AI models have been implemented in software, but a software solution can be inefficient in terms of performance and energy (e.g., per token). Software solutions can be sufficient for conducting time-insensitive calculations, but not for applications that may demand real-time performance.

While general-purpose solutions like Graphics Processing Units (GPUs), Tensor Processing Units (TPUs), and Central Processing Units (CPUs) can be utilized for both training and inference, they are not cost-effective for inference on a given model alone due to their inherent design to handle a wide range of tasks, including the repetitive loading of the LLM including its weights.

In a GPU-based solution, model weights are loaded from memory every time a machine learning inference task is performed. This process consumes significant power and time, particularly for complex models. GPUs are designed in a generic manner to handle a wide range of tasks, making them inefficient for dedicated tasks like inference on a pre-trained model alone.

In a field programmable gate array (FPGA) based solution, programmable hardware can be customized to perform specific tasks, including loading and handling LLM weights, to make machine learning inference more efficient. While FPGAs offer flexibility, they can require significant programming effort and expertise to be utilized effectively. They also have lower performance compared to dedicated hardware solutions and are not as power efficient and not cost-effective.

In CPU-based solutions, CPUs can be programmed to perform machine learning inference tasks. CPUs are not suitable for large-scale matrix multiplications which can be essential for machine learning inference tasks. They also consume more power and are slower in comparison to dedicated solutions.

In the inferencing process with GPU acceleration, the user initiates the sequence by providing input data for analysis. This data undergoes tokenization and embedding generation, transforming it into a format suitable for machine learning models. The system then loads the pre-trained model into memory, along with its associated weights, which are the learned parameters crucial for making predictions. Once the GPU is initialized, the model weights and embeddings are transferred to the High Bandwidth Memory (HBM), a specialized memory architecture designed for high-speed data transfer. The data is then shuttled from the HBM to the GPU cores, where the actual inferencing computations take place in parallel. After processing, the data is moved back to the HBM. A significant challenge in this workflow is the data transfer between the HBM and the GPU cores. While HBM offers high bandwidth, the repeated movement of data can create a bottleneck, leading to latency issues that can diminish the overall performance gains from GPU acceleration. Each transfer incurs a cost in time and energy, and when dealing with large datasets or complex models, these costs can accumulate, impacting the efficiency of the inferencing process. Optimizing data movement, reducing the frequency of transfers, and ensuring that the GPU cores have sufficient work to perform while data is in transit are critical considerations in maximizing the performance of GPU-accelerated machine learning inference.

### Technical Solution: Models-On-Silicon

Various other solutions, while capable of performing machine learning inference tasks, are lacking in one aspect or another. To overcome at least some of these limitations, a dedicated, efficient, and cost-effective chip can be designed and implemented for machine learning inference. In particular, the chip can be designed to support and perform inference according to a transformer-based neural network, such as an open-source transformer-based neural network or an open-source LLM.

According to one aspect, the disclosed solution, referred to herein as models-on-silicon, introduces a groundbreaking chip architecture that is specifically designed to encapsulate the LLM weights and inference architecture directly onto the hardware. This unique models-on-silicon architecture design optimizes a given LLM by etching the weights onto the chip, eliminating the recurring task of loading these weights and model into GPUS every time.

According to one aspect, the models-on-silicon architecture utilizes a sequential read-only memory to store one or more weights of a transformer-based neural network. The weights of the transformer-based neural network are thus etched onto the sequential read-only memory and fixed onto the hardware. An application processor no longer has to load weights onto memory or compile a processing graph of a transformer-based neural network and load the compiled instructions onto the GPU. In some embodiments, the sequential read-only memory may power up an active word line and a next active word line and powers down one or more other word lines.

According to one aspect, the models-on-silicon architecture includes a memory to store a key-value cache for the transformer-based neural network. The memory to store the key-value cache may be a sequential read memory. The key-value cache may be a sequential write memory.

The one or more memories in the models-on-silicon architecture can be sequential and do not require random-access. Each line can be read in its designated time slot along with the operation for it. This maximizes performance, simplifies routing, and enables quick access to data, weights, key-value cache, and/or activations.

According to one aspect, the models-on-silicon architecture facilitates placing one or more memories in close proximity to the custom-built circuits that are performing the logic operations. The architecture not only frees up the need to persistently retrieve an LLM's weights from a main memory (e.g., a large static random-access memory (SRAM)) for each computation, but also allows the data to be strategically positioned in close proximity to the logic operations.

According to one aspect, the models-on-silicon architecture has one or more (custom-built) circuits to perform the logic operations and/or calculations of the transformer-based neural network. The custom-built or purpose-built circuits encapsulate operations of the inference architecture directly on hardware. Custom circuits can be highly efficient and have low power consumption and smaller area.

According to one aspect, the one or more circuits include a read-only memory to store a look up table (LUT) having one or more precomputed values of an exponent function.

According to one aspect, the one or more circuits include a read-only memory to store a look up table having one or more precomputed values of a sigmoid linear unit function.

According to one aspect, the one or more circuits include a (custom-built) multiplier circuit to multiply an embedding value of an embedding vector of the transformer-based neural network and a weight value of a weight matrix of the transformer-based neural network. In some cases, the weight value can be read from a sequential read-only memory.

In some cases, the multiplier circuit is specifically designed to perform multiplication of an 8-bit floating-point (FP8) number and a 6-bit floating-point (FP6) number. For example, the weight value may be a 6-bit floating-point number, and the embedding value is an 8-bit floating-point number. In some cases, the multiplier circuit is specifically designed to perform multiplication of an FP8 number and a 4-bit floating-point (FP4) number. For example, the weight value may be a 4-bit floating-point number, and the embedding value is a 8-bit floating-point number. In some cases, the multiplier circuit is specifically designed to perform multiplication of an FP6 number and an FP4 number. For example, the weight value may be a 4-bit floating-point number, and the embedding value is a 6-bit floating-point number. In some cases, the multiplier circuit is specifically designed to perform multiplication of a 16-bit floating-point (FP16) number and a FP16 number.

According to one aspect, the multiplier circuit includes a multiplexer to allow the bypassing of the etched weight value and use a different weight value instead. In some cases, an application processor may selectively apply one or more weight values of a low-rank weight matrix that was generated by fine-tuning the transformer-based neural network. In such cases, the weight value to be used or processed in the multiplier circuit can be read from a read-write memory storing the one or more weight values of the low-rank weight matrix. In some cases, one or more etched weight values may have errors, and one or more repair weight values can be selectively applied in place of the etched weight values. In such cases, the weight value to be used or processed in the multiplier circuit can be read from a read-write memory storing one or more repair weight values for the transformer-based neural network.

According to one aspect, the one or more circuits include a tree adder circuit. According to one aspect, the one or more circuits include a tree comparator circuit. The tree/hierarchical structures facilitate processing a large number of inputs in parallel to produce a final output. The tree/hierarchical structures can perform processing in a feedforward manner without recursion. In some cases, the adders in the tree adder operate with wide bit-width numbers to avoid overflow.

According to one aspect, the models-on-silicon architecture includes a flow control circuit (also referred to as a sequencer, a sequencer circuit, an orchestrator circuit, etc.). The flow control circuit orchestrates the operations of a transformer-based neural network in a feedforward manner, as if following a predetermined timing sequence or recipe of operations. Because the models-on-silicon chip implements a predetermined inferencing task of a predetermined transformer-based neural network, the timing sequence of operations (including how many clock cycles each operation takes, the data flow between operations, etc.) is known or established ahead of time. The timing sequence can specify one or more operations of an inferencing task of the transformer-based neural network to be performed at a given clock cycle. The timing sequence may specify the overall sequence of operations to be performed. The timing sequence can specify the data being processed by a given operation. The timing sequence can specify the data being generated by a given operation. The flow control circuit may control gates, muxes, flip-flops, etc., to execute the timing sequence and orchestrate the (custom-built) circuits to perform the operations according to the timing sequence. The flow control circuit can control the data flow into and/or out of the one or more (custom-built) circuits. The flow control circuit can enable and/or disable the one or more (custom-built) circuits according to a predetermined timing sequence. The flow control circuit may include digital logic to generate control signals, timing signals, trigger signals, etc., which can be used to control one or more of: gates, muxes, flip-flops, and custom circuits. The signals can cause the one or more (custom-built) circuits to follow and execute operations of the transformer-based neural network, e.g., in a feedforward manner, according to the predetermined timing sequence.

According to one aspect, the models-on-silicon chip architecture embeds a feedforward-only transformer-based neural network. In comparison to other solutions, the models-on-silicon chip architecture avoid the need to implement software, complex program control or counters, or back propagation, since the model is only feedforward. The models-on-silicon chip architecture and the hardware execution timing sequence involve only forward pass.

The models-on-silicon chip encapsulates a LLM inferencing model on a single chip and includes a token interface that can demand low bandwidth per inferencing task into the system-on-a-chip (SoC). The models-on-silicon architecture ensures a highly scalable solution, as any number of SoCs can be connected in parallel to handle multiple batches of inference requests simultaneously with low overhead. The models-on-silicon design revolutionizes the way AI inference tasks are handled, making it both cost-effective and scalable.

One of the advantages of the disclosed solution is its cost-effectiveness. Unlike general-purpose GPUs, this chip is specifically designed to handle AI inference tasks, and thus, does not carry any overhead of unnecessary or general-purpose functionalities. This focus on specific tasks makes it a much more cost-effective solution. The disclosed solution enables faster machine learning inference and reduces power consumption, can offer offering a more efficient and environmentally friendly solution for artificial intelligence tasks.

This disclosed models-on-silicon solution solves the problem of cost, high power consumption, and time delay, in AI inference by integrating the LLM weights and model onto the hardware itself, effectively removing the need to load weights onto the GPU every load. In some embodiments, the chip includes custom-built circuits for matrix multiplication, allowing for efficient computation. By embedding the weights and the model onto the hardware, power consumption is significantly reduced, and inference tasks are completed faster, while cost is low. The disclosed solution can be visualized as a chip with multiple modules for computations and dedicated sections for weight storage. Various aspects can together contribute to increased performance, scale, reduction of power consumption and area on the chip, reduction in real-time compute calculations, and more.

By hardcoding the LLM weights and architecture onto the chip, the time and power to load these weights from memory are significantly reduced. As a result, inference tasks can be executed faster, providing a significant performance boost. The disclosed solution reduces power consumption by eliminating the need to repeatedly load weights and models from memory for each inference task. This makes the solution more power efficient, reducing the overall operational cost, and making it a more environmentally friendly solution. Unlike general-purpose GPUs or FPGAs, this dedicated chip is specifically designed to handle AI inference tasks. Therefore, it does not carry any overhead of unnecessary or general-purpose functionalities, making it a more cost-effective solution. Due to encapsulation of a full LLM inferencing model on a single chip and a token interface, requiring a very low bandwidth per inferencing task into the SoC, a number of SoCs can be connected to in parallel to simultaneously handle multiple batches of inference requests with low overhead, making the disclosed solution scalable. Because the model and weights are hardcoded into the hardware, model integrity is assured and less susceptible to manipulation. The disclosed solution can be more secure. The power efficiency and performance boost offered by this invention make it ideal for real-time computing, such as edge computing, mobile and Internet of Things (IoT) applications where resources are limited, and low latency may be required.

Relative to solutions where model weights are stored in HBM, the models-on-silicon chip is much faster, with 150× better latency, because the data is located where it is used. In addition, the models-on-silicon chip is more power efficient due to the use of sequential read-only memories with 3000× better power efficiency. Relative to solutions that support generic matrix to matrix multiplication, vector to matrix multiplication, and matrix to vector multiplication, the models-on-silicon chip implements a predefined matrix multiplier to perform vector dot product operations that multiply an FP8 valued vector and FP6 valued matrix to enable optimization in the hardware bit level, save die area, enable faster operations, and reduce power. Relative to solutions that compute values for activations, the models-on-silicon chip implements predefined look up tables with values precalculated in advance to save compute calculations in real-time. Relative to solutions where the model definition has to be compiled and loaded to run the model, the models-on-silicon chip while being less flexible, can enable highly optimized hardware design, save die area, enable faster operation, and reduce power.

Applications that can potentially benefit from having a more efficient solution may include huge AI models with hundreds of billions of parameters deployed on GPUs, TPUs, CPUs and cloud computing environments, mid-to-small AI models with a few to a dozen billion parameters deployed in humanoid robots and personal computers, and tiny AI models with less than a billion parameters deployed on mobile devices. Use cases that can benefit from having a more efficient solution may include real-time speech-to-text, real-time text-to-speech, dictation, translation, personal assistance, LLM operating system, LLM supervisor activating experts like coding LLM and productivity LLM, autonomous robots with reasoning, humanoids, cars, appliances, smart carts, smart factories, video-to-tokens, generating video tokens for LLMs training at scale, etc.

### Exemplary Chip Architecture

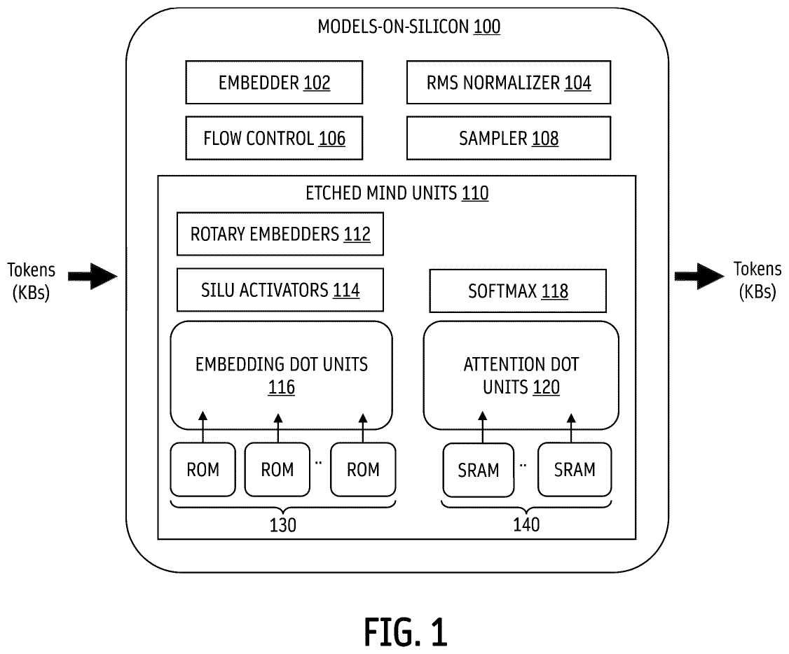

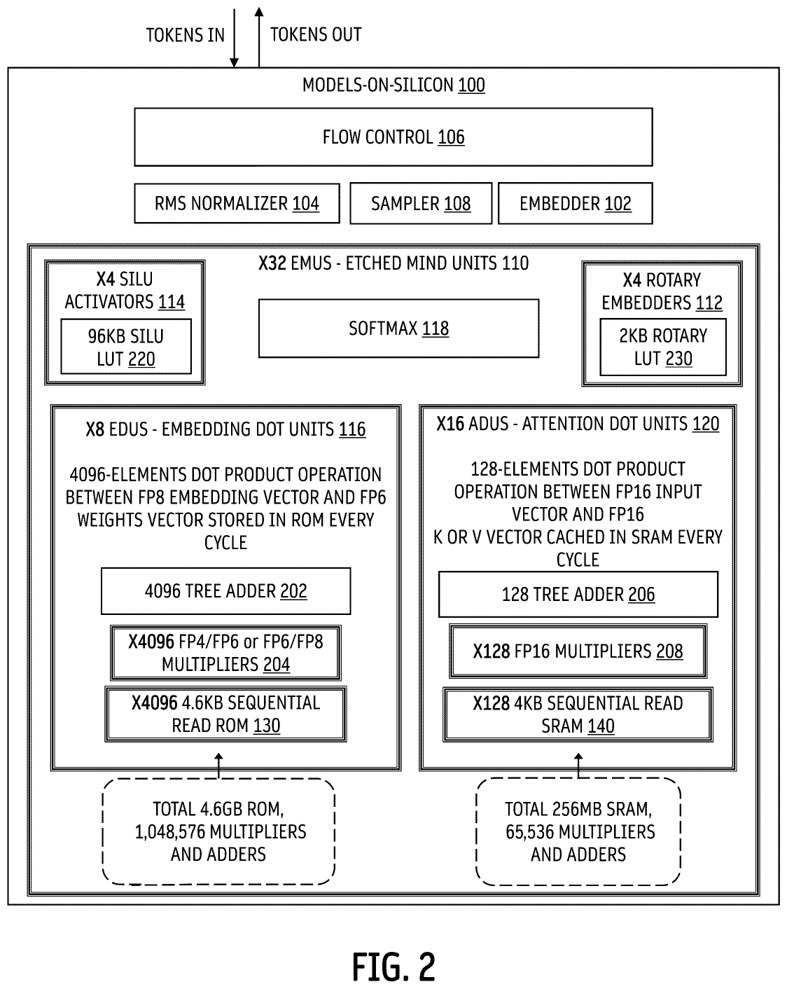

FIG. 1 illustrates an exemplary chip architecture, according to some embodiments of the disclosure. FIG. 2 illustrates exemplary details within the parts of the exemplary chip architecture, according to some embodiments of the disclosure. Models-on-silicon chip 100 is depicted in both figures to illustrate exemplary implementations.

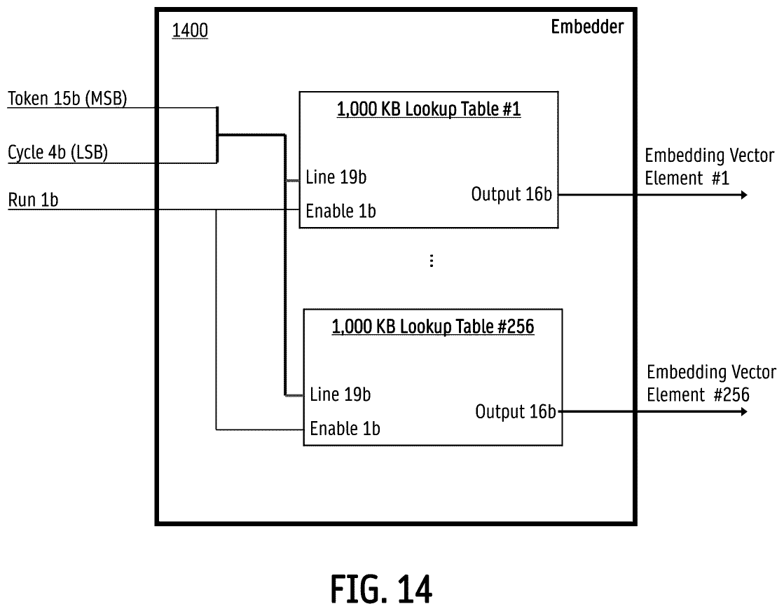

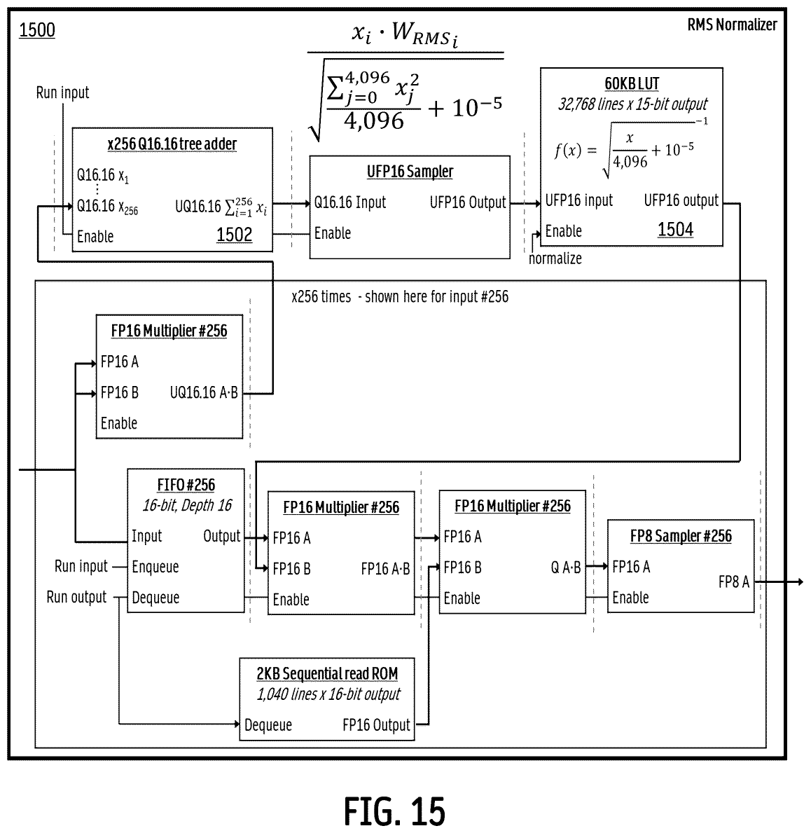

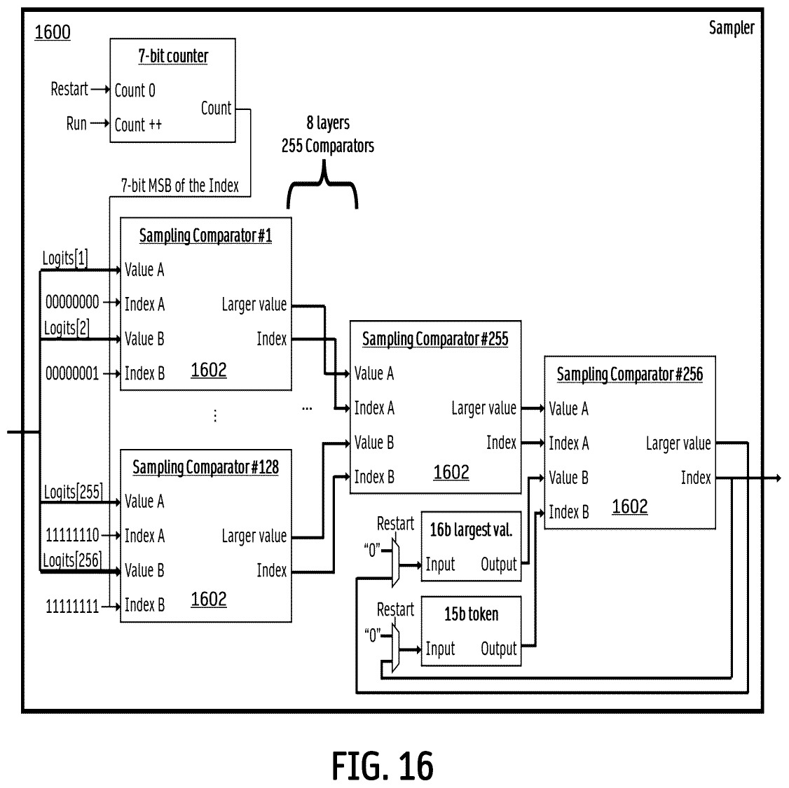

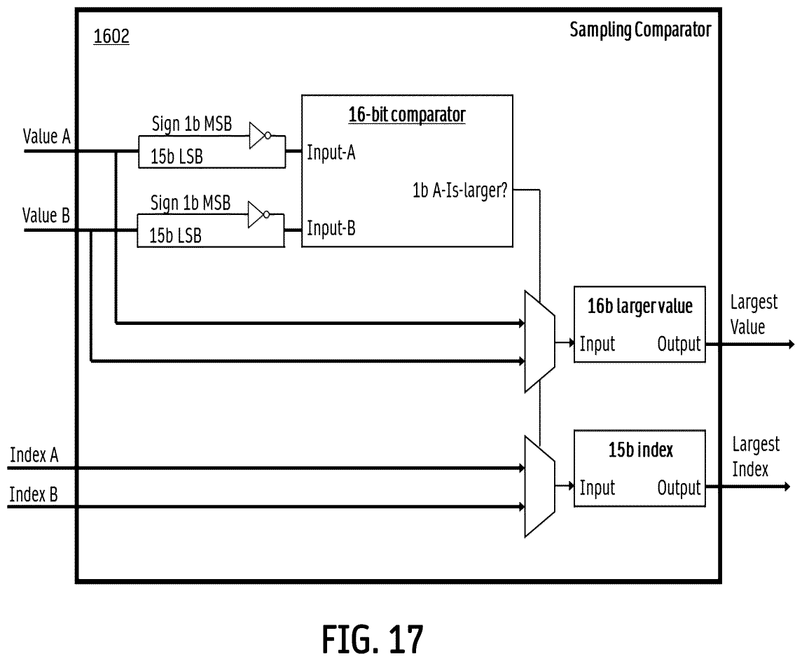

A “models-on-silicon” chip 100 illustrated in FIGS. 1-2 may include one or more of: embedder circuit 102, RMS normalizer circuit 104, flow control circuit 106, sampler circuit 108, and one or more etched mind units 110 (EMUs). Exemplary implementations of embedder circuit 102 are illustrated in FIG. 14. Exemplary implementations of RMS normalizer circuit 104 are illustrated in FIG. 15. Exemplary implementations of sampler circuit 108 are illustrated in FIGS. 16-17.

An EMU of one or more etched mind units 110 may include one or more of: one or more rotary embedder circuits 112, one or more SILU activator circuits 114, one or more SoftMax circuits 118, one or more embedding dot unit circuits (EDUs) 116, one or more attention dot unit circuits (ADUs) 120.

In one implementation, an EDU of the one or more embedding dot unit circuits may carry out a (4096-elements) dot product operation between FP8 embedding vector and FP6 weights vector stored in one or more ROMs 130, e.g., every cycle. The dot product operation can be performed using one or more tree adders 202 and one or more multipliers 204 in the EDU.

In one implementation, an ADU of the one or more attention dot unit circuits 120 may carry out a (128-elements) dot product operation between FP16 input vector and FP16 K or V vector cached in one or more SRAMs 140, e.g., every cycle. The dot product operation can be performed using one or more tree adders 206 and one or more multipliers 208 in the ADU.

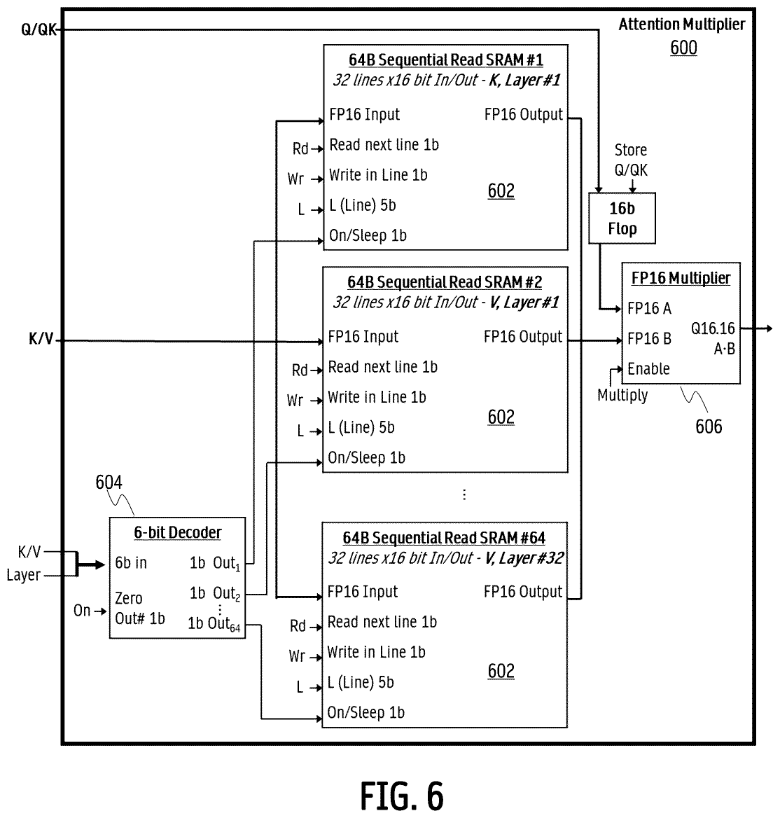

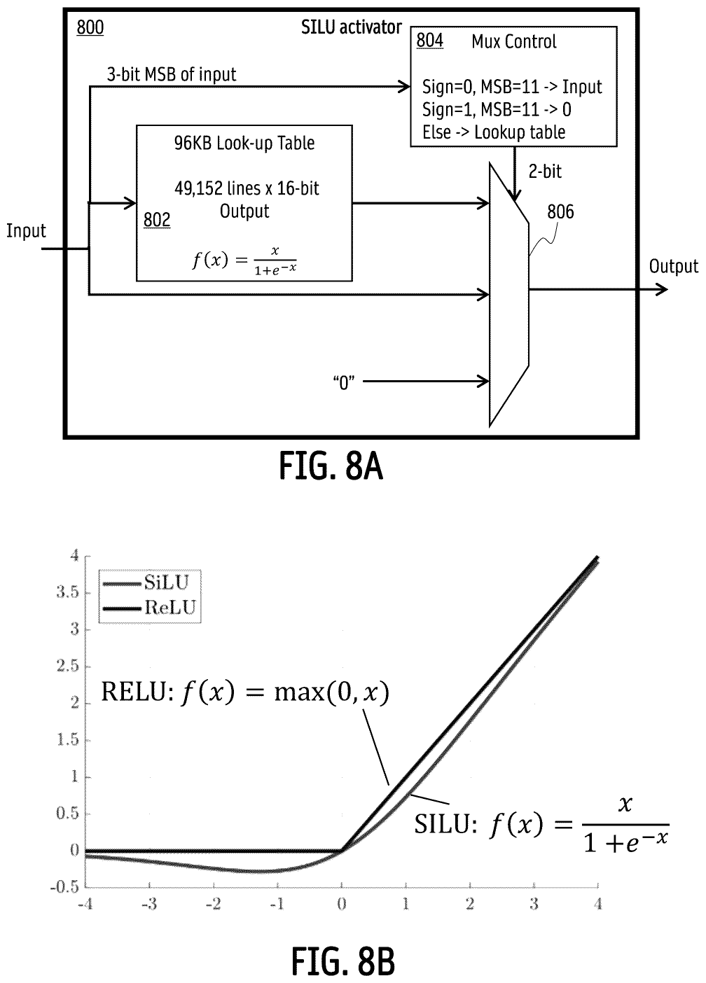

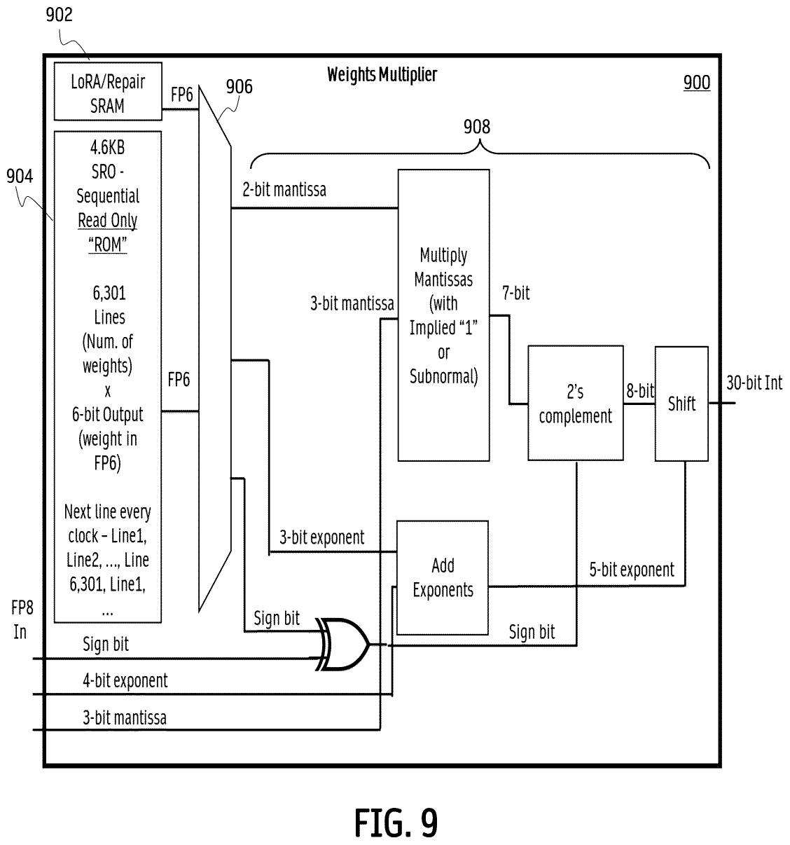

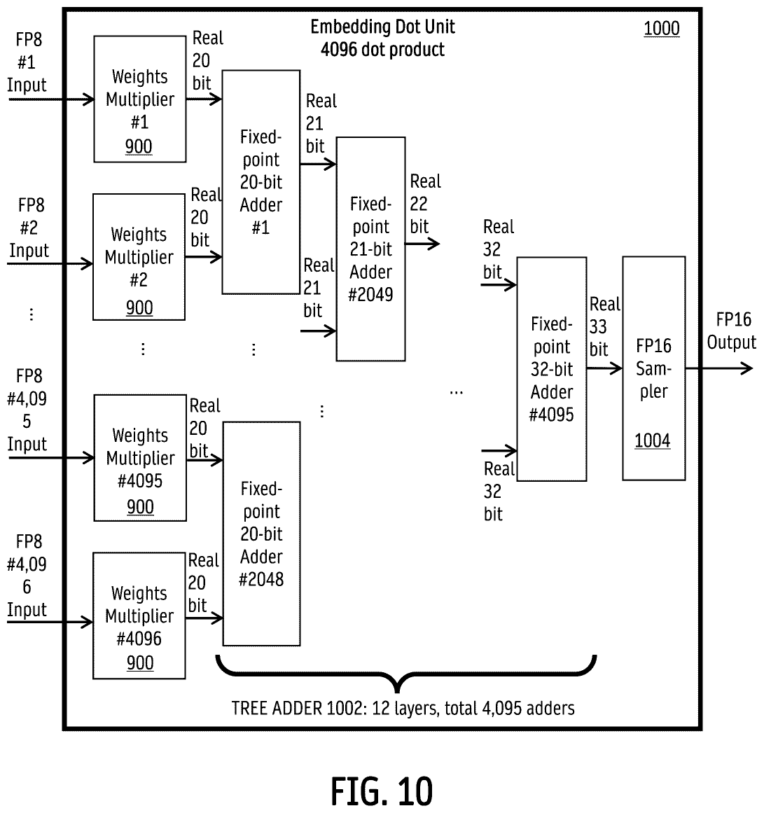

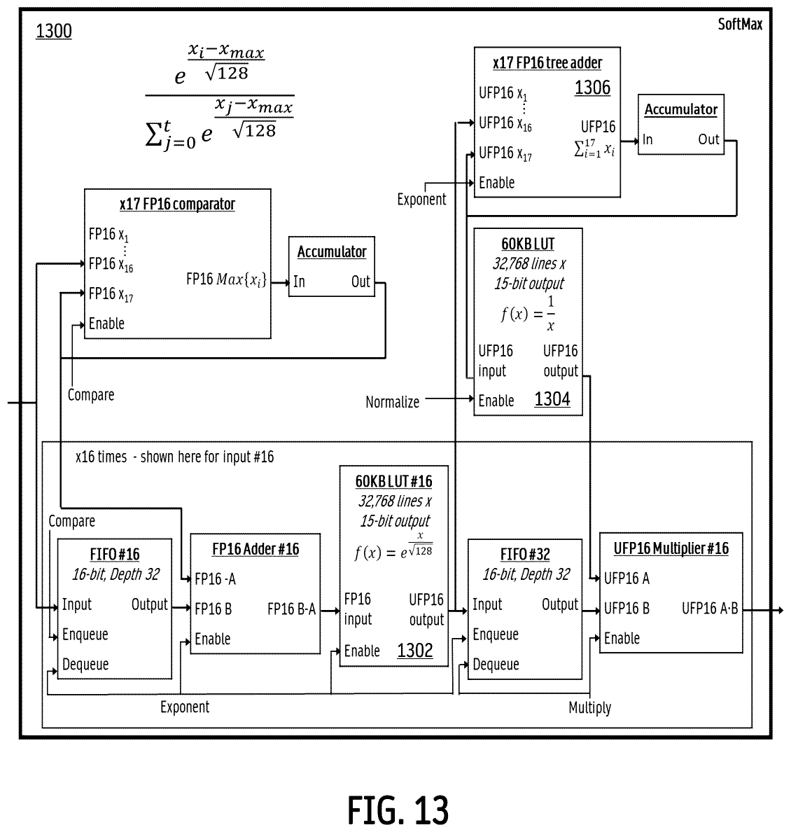

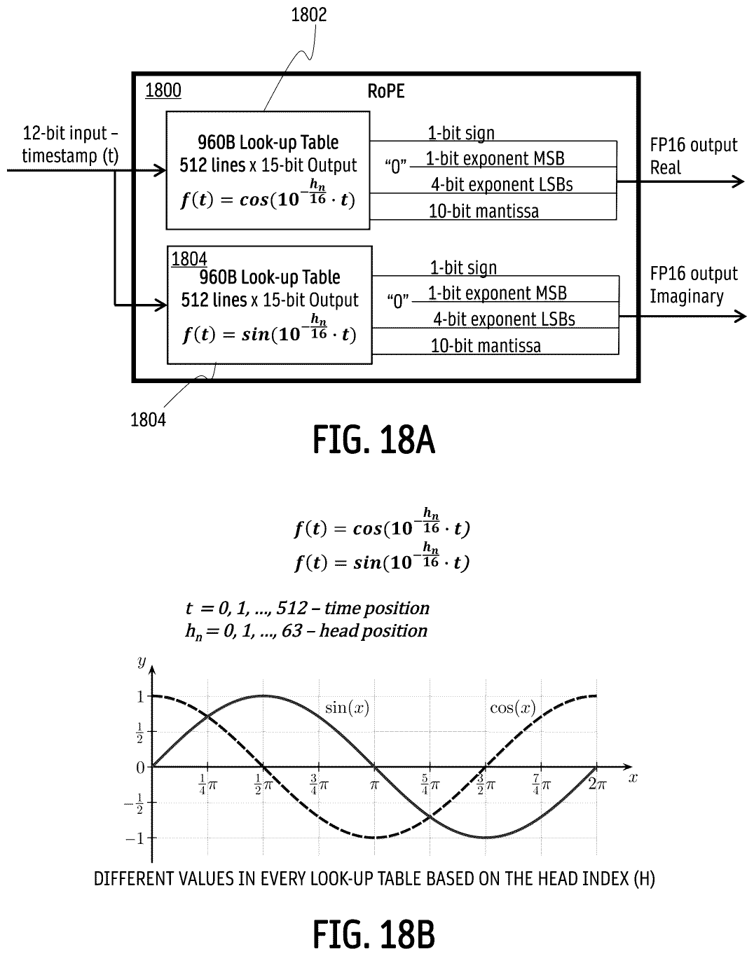

Exemplary implementations of one or more rotary embedder circuits 112 are illustrated in FIGS. 18A-18B. Exemplary implementations of one or more SILU activator circuits 114 are illustrated in FIGS. 8A-8B. Exemplary implementations of one or more SoftMax circuits 118 are illustrated in FIG. 13. Exemplary implementations of one or more EDU circuits 116 are illustrated in FIGS. 9-10. Exemplary implementations of one or more ADU circuits 120 are illustrated in FIG. 6.

An EDU of one or more EDU circuits 116 can include one or more tree adders 202. The EDU may include one or more multipliers 204. A multiplier in one or more multiplier 204 may multiple two values, such as two floating-point values. For example, one or more multipliers 204 may include an FP4/FP6 multiplier. One or more multipliers 204 may include an FP4/FP8 multiplier, one or more multipliers 204 may include an FP6/FP8 multiplier. One or more multipliers 204 may be specifically designed to perform multiplication of values or data having predetermined representations (e.g., FP4, FP6, FP8, FP12, INT8, etc.). One or more multipliers 204 may read data from one or more ROMs 130. One or more tree adders 202 may add multiplication results produced by one or more multipliers 204 together.

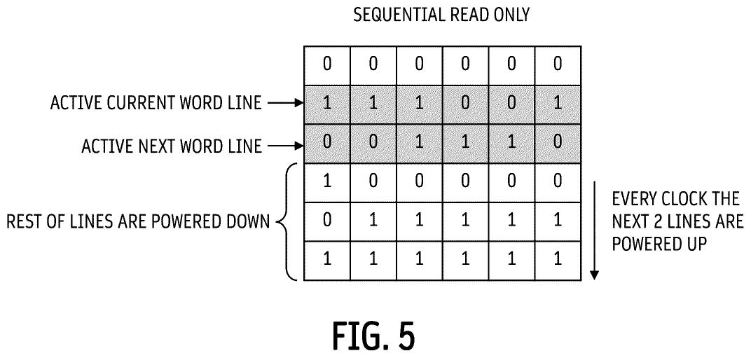

An EMU of one or more etched mind units 110 may include one or more ROMs 130 that can store and provide data to one or more circuits performing logic operations in an EDU of EDU circuits 116. One or more ROMs 130 may include one or more sequential read-only memories, which may be placed in proximity to the circuits performing logic operations in the EDU. Exemplary implementations of the one or more ROMs 130 are illustrated in FIG. 5.

An ADU of one or more ADU circuits 120 can include one or more tree adders 206. The ADU may include one or more multipliers 208. A multiplier in one or more multiplier 204 may multiple two values, such as two floating-point values. For example, one or more multipliers 208 may include an FP16/FP16 multiplier. One or more multipliers 208 may be specifically designed to perform multiplication of data having predetermined representations (e.g., FP4, FP6, FP8, FP12, FP16, INT8, etc.). One or more multipliers 208 may read data from one or more SRAMs 140. One or more tree adders 206 may add multiplication results produced by one or more multipliers 208 together.

An EMU of one or more etched mind units 110 may include one or more SRAMs 140 that can store and provide data to one or more circuits performing logic operations in an ADU of ADU circuits 120. One or more SRAMs 140 may include one or more sequential read/write memories, which may be placed in proximity to the circuits performing logic operations in the ADU.

In some embodiments, models-on-silicon chip 100 is a model-specific integrated circuit. The integrated circuit includes a sequential read-only memory (e.g., one or more ROMs 130) to store one or more weight values of a weight matrix of a transformer-based neural network. The integrated circuit includes one or more circuits to perform one or more operations of an inferencing task of the transformer-based neural network (e.g., various circuits illustrated in FIGS. 1-2). The integrated circuit includes a sequencer circuit to orchestrate the one or more circuits according to a predetermined timing sequence of the transformer-based neural network (e.g., flow control circuit 106).

Flow control circuit 106 (also referred to as a sequencer circuit) plays a role in orchestrating various circuits to execute operations according to a predetermined timing sequence. Advantageously, a transformer-based neural network operates in a feedforward manner. The sequence of operations of the transformer-based neural network corresponding to different layers of the neural network can be determined and mapped into a timing sequence of operations. The timing sequence of operations may include stages of operations, one following another. In a particular time slot or stage in the timing sequence, data can be moved in, processed, and moved out to be processed in the next/following time slot, in a feedforward, progressive manner. Flow control circuit 106 thus can implement digital logic to generate clock edges/signals (e.g., control signals, timing signals, enable signals, disable signals, trigger signals, etc.) to orchestrate operations to be performed according to the timing sequence. Flow control circuit 106 can control data flow into and/or out of the one or more circuits. Flow control circuit 106 can enable and/or disable the one or more circuits according to a predetermined timing sequence.

According to one aspect, the models-on-silicon chip 100 illustrated in FIGS. 1-2 provides and implements at least a part of or an entire generative AI model (e.g., a transformer-based neural network, an LLM, etc.) in a single chip or integrated circuit. This involves integrating the generative AI model into a single chip, e.g., as illustrated as models-on-silicon chip 100 in FIGS. 1-2. The chip 100 receives tokens in and outputs tokens out. The entire architecture, weights, and flow of the generative AI model can be embedded into the chip 100.

In one exemplary implementation where chip 100 embeds a specific transformer-based neural network, there are 32 instances of EMUs 110 on models-on-silicon chip 100. In an EMU, there may be 4 instances of SILU activator circuit 114. An instance of SILU activator circuit 114 may include a look up table 220, e.g., a 96 Kilobyte (KB) look up table. In an EMU, there may be 4 instances of rotary embedder circuit 112. An instance of rotary embedder circuit 112 may include a look up table 230, e.g., 2 KB look up table. In an EMU, there may be 8 instances of EDU circuit 116. In an EMU, there may be 16 instances of ADU circuit 120.

An instance of an EDU may include tree adder 202, e.g., a tree adder to add 4096 inputs. An instance of an EDU may include 4096 instances of multiplier 204. An instance of EDU may include 4096 instances of sequential read-only memory 130, e.g., 4.6 KB sequential read-only memory. A sequential read-only memory may be provided for an individual multiplier, e.g., in proximity to the multiplier. In total, one or more EDU circuits 116 may include 4.6 Gigabytes (GB) of sequential read-only memory, and 1,048,576 multiplier circuits and adder circuits.

An instance of an ADU may include tree adder 206, e.g., a tree adder to add 128 inputs. An instance of an ADU may include 128 instances of multiplier 208. An instance of ADU may include 128 instances of sequential read/write memory 140, e.g., 4 KB sequential read/write memory. A sequential read/write memory may be provided for an individual multiplier, e.g., in proximity to the multiplier. In total, one or more ADUs may include 256 Megabytes (MB) of sequential read/write memory, and 65,536 multiplier circuits and adder circuits.

According to one aspect, the chip 100 illustrated in FIGS. 1-2 has the actual components, blocks, and parts that make up the operations of an inference task of a transformer-based neural network model architecture. The chip 100 thus includes circuits that implement one or more transformer blocks. The circuits may implement various operations in a transformer block, e.g., SoftMax, attention, RMS normalizer, etc. For example, embedding the chip with an open-source model would mean that the way the hardware blocks are connected to each other on the chip would match the architecture of the open-source model.

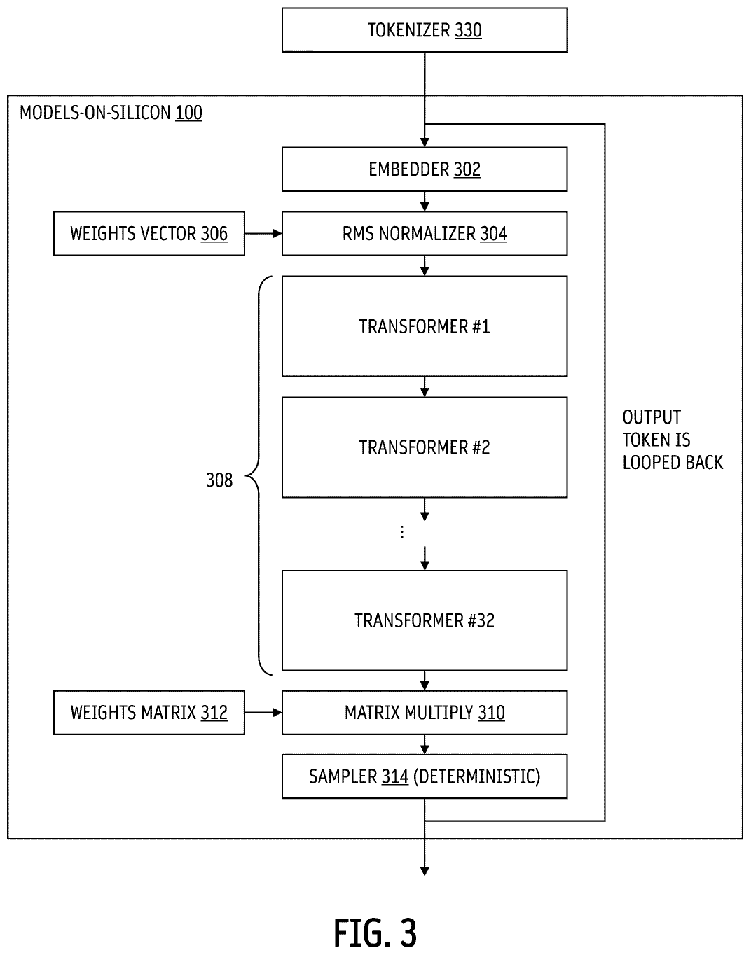

FIG. 3 illustrates embedding an exemplary open-source model onto the chip, according to some embodiments of the disclosure. As illustrated, the model includes one or more functional blocks, such as tokenizer 330, embedder 302, RMS normalizer 304 operating on weights vector 306, one or more transformers 308 (e.g., 32 transformer blocks), matrix multiply 310 operating on weight matrix 312, and sampler 314 (e.g., deterministic sampler). Some functional blocks of the model, such as embedder 302, RMS normalizer 304 operating on weights vector 306, one or more transformers 308, matrix multiply 310 operating on weight matrix 312, and sampler 314, as seen in FIG. 3 can be embedded as circuits onto the models-on-silicon chip 100, as illustrated in FIGS. 1-2.

Input data (e.g., input words) may be tokenized by tokenizer 330, and input tokens may be output by tokenizer 330. The input tokens (e.g., an input token may be represented as a 15-bit integer) may be provided as input to embedder 302. Embedder 302 may include one or more look up tables. Embedder 302 may output a vector (e.g., a vector having 4096 values). In some embodiments, the values of the vector are FP16 values. The vector may be provided as input to RMS normalizer 304. RMS normalizer 304 may perform the function:

$$\frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}}$$

RMS normalizer 304 may read weights vector 306 (Wₙ₃ weights vector having 4096 values) from a sequential read-only memory. In some embodiments, the values of weights vector 306 are FP6 values. RMS normalizer 304 may output a vector (e.g., a vector having 4096 values). In some embodiments, the values of the vector are FP8 values. The vector may be processed by one or more transformers 308, which may output a vector (e.g., a vector having 4096 values) to be processed by matrix multiply 310. In some embodiments, the values of the vector of FP8 values. Matrix multiply 310 may read weight matrix 312 (W_{cls} weight matrix (e.g., a matrix having FP6 values) a sequential read-only memory. Matrix multiply 310 may perform matrix multiplication between the vector from one or more transformers 308 and weight matrix 312. Matrix multiply 310 may output a vector (e.g., a vector having 128,256 values). In some embodiments, the values of the vector may include FP16 values. The vector is passed onto sampler 314 to get an index of the largest number in the vector and output an output token (e.g., an output token may be represented as a 15-bit integer). The output token may be looped back as an input to embedder 302, since the model is auto-regressive. Timestep may increase by 1 to trigger the model to produce the next output token.

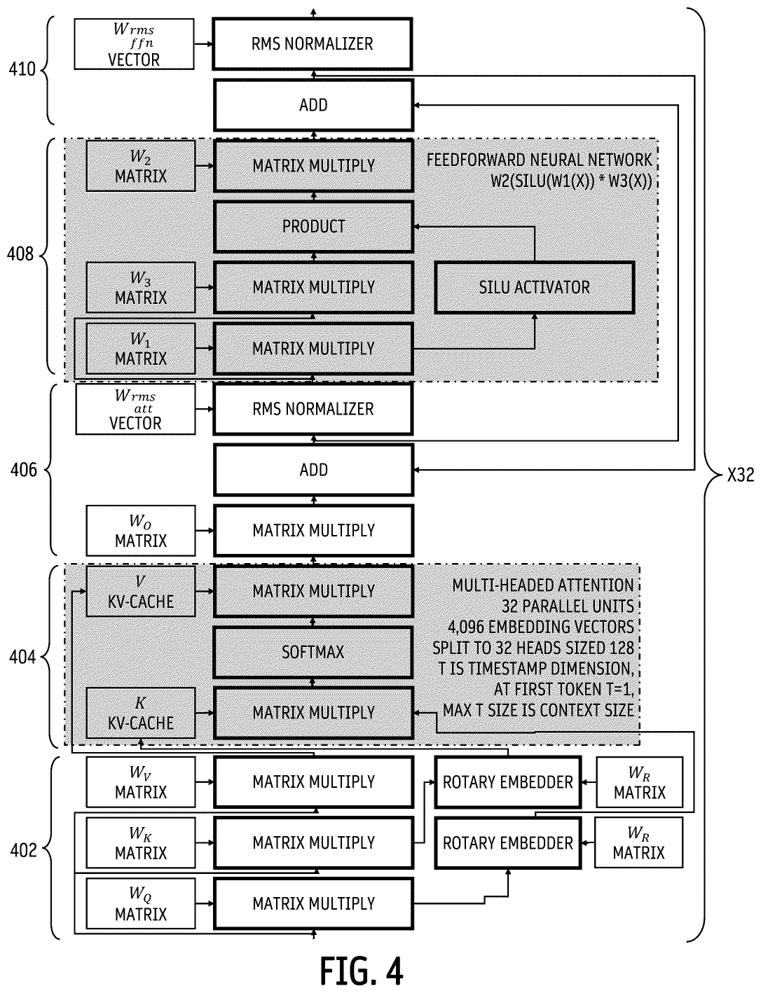

FIG. 4 illustrates exemplary hardware blocks or circuits representing and corresponding to an exemplary open-source model, according to some embodiments of the disclosure. Specifically, the one or more transformers 308 seen in FIG. 3 are depicted in greater detail in FIG. 4. The functional blocks of the one or more transformers 308 (e.g., representing one or more operations of an inferencing task of a transformer-based neural network) seen in FIG. 3, such as matrix multiply, rotary embedder, SoftMax, add, RMS normalizer, SILU activator, and product, can be embedded onto the chip as the circuits as illustrated in FIGS. 1-2. Specifically, the functional blocks can be implemented in hardware as an EMD (e.g., one or more etched mind units 110 seen in FIGS. 1-2). In some implementations, there are 32 transformers, and thus the 32 transformers can be implemented in hardware as 32 EMDs. The weight vectors and matrices can be stored in sequential read-only memories (e.g., one or more ROMs 130) as depicted in FIGS. 1-2. The KV-cache can be stored in sequential read/write memories (e.g., one or more SRAMs 140) as depicted in FIGS. 1-2. The functional blocks of one or more transformers 308 thus can be directly implemented as circuits on the chip, and the sequencer circuit can configure the circuits corresponding to the functional blocks to operate according to the data and operational flow illustrated in FIG. 4. The circuits (e.g., hardware blocks) of the EMU are coupled to each other according to the data and operational flow as illustrated in FIG. 4.

A rotary embedder seen in FIG. 4 may implement the following functions:

$$f ( {x}_{i} ) = {x}_{i} \cdot {w}_{r} - {x}_{i + 1} \cdot {w}_{i}$$

$$f ( {x}_{i + 1} ) = {x}_{i} \cdot {w}_{i} + {x}_{i + 1} \cdot {w}_{r}$$

A SoftMax block seen in FIG. 4 may implement the following:

$$\frac{{e}^{\frac{{x}_{i} - {x}_{max}}{\sqrt{128}}}}{{\sum }_{j = 0}^{t} {e}^{\frac{{x}_{j} - {x}_{max}}{\sqrt{128}}}}$$

An add block seen in FIG. 4 may implement element-wise addition:

$$f ( x , y ) = x + y$$

A product block seen in FIG. 4 may implement element-wise multiplication:

$$f ( x , y ) = x \cdot y$$

A SILU activator block seen in FIG. 4 may implement the following:

$$f ( x ) = \frac{x}{1 + {e}^{- x}}$$

The data and operational flow illustrated in FIG. 4 can include different groups of operations, e.g., group 402, group 404, group 406, group 408, and group 410, being performed or arranged in a feedforward manner. Group 402 includes two rotary embedders and three matrix multiply blocks. Group 402 may be embedded onto models-on-silicon chip 100 as one or more rotary embedder circuits 112 and one or more EDU circuits 116. Group 404 includes two matrix multiply blocks and a SoftMax block. Group 404 may be embedded onto models-on-silicon chip 100 as one or more ADU circuits 120 and one or more SoftMax circuits 118. Group 406 includes a matrix multiply block, an add block, and an RMS normalizer block. Group 406 may be embedded onto models-on-silicon chip 100 as one or more EDU circuits 116, and RMS normalizer circuit 104. Group 408 includes three matrix multiply blocks, a SILU activator block, and a product block. Group 408 may be embedded onto models-on-silicon chip 100 as one or more EDU circuits 116 and one or more SILU activator circuits 114. Group 410 includes an add block and an RMS normalizer block. Group 408 may be embedded onto models-on-silicon chip 100 as one or more EDU circuits 116 and RMS normalizer circuit 104.

### Sequential Read-Only Memory

FIG. 5 illustrates sequential read-only (SRO) memory, according to some embodiments of the disclosure. According to one aspect, the models-on-silicon chip has one or more instances of SRO memories. SRO memory is a type of memory storage, utilizing ROMs, that allows data to be read sequentially but not written or modified after the values have been etched onto the ROM. The rest of the ROM can be shutdown to reduce power and area. In some embodiments, the models-on-silicon chip has one or more SRO memories. The SRO memory powers up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The SRO memory can power down the rest of the word lines, or the rest of the word lines in the SRO memory can remain powered down. At the next clock or time slot, the active current word line is powered down, the active next word line is already powered up, and a further active next word line is powered up. At every clock or time slot, two word lines are powered up in the SRO memory. The two active word lines that are powered up gets moved by one word line down the SRO memory at every clock or time slot.

In some embodiments, one or more SRO memories may be provided on the chip to store various weight matrices for a transformer model:

| Num. Lines | Layer | Matrix |
|---|---|---|
| 16 | 0 | Wq |
| 4 | 0 | Wk |
| 4 | 0 | Wv |
| 16 | 0 | Wo |
| 112 | 0 | W1 or W3 |
| 56 | 0 | W2 |
| . . . | . . . | . . . |
| 16 | 31 | Wq |
| 4 | 31 | Wk |
| 4 | 31 | Wv |
| 16 | 31 | Wo |
| 112 | 31 | W1 or W3 |
| 56 | 31 | W2 |
| 16 | 31 | Wq |
| 501 | — | Wcls |

There may be 1,048,576 Weights ROMs (e.g., SRO memories) in models-on-silicon chip 100 illustrated in FIGS. 1-4. A ROM can hold weights in FP6 format. A ROM output can be a 6-bit value. A weights ROM can hold a specific weight matrix column, since a weights ROM can output a single number out of the 4096-element vector being multiplied in the EDU. A weights ROM can hold one of 256 weight matrix rows, since there are 256 EDUs working in parallel and producing 256 numbers per clock cycle. A ROM can hold matrix rows 1, 257, . . . , and another ROM can hold matrix rows 2, 258, and so forth. In some cases, a weights ROM can hold elements from (all) weights matrices in (all) layers, since a weights ROM sequentially outputs the number the matrix multiplier is using for (all) transformers and matrices, as the weights multipliers are shared across all layers and weights matrices. The weights ROM hold (only) the linear layers' weights. There may be one or more dedicated ROMs for the embedder and RMS normalizer units.

### Sequential Read/Write Memory in an Attention Multiplier Circuit

FIG. 6 illustrates sequential read/write (SRW) memory used in attention multiplier circuit 600, according to some embodiments of the disclosure. According to one aspect, the models-on-silicon chip has one or more SRW memories. The SRW memory involves using an SRAM in a special configuration that it is not dynamically readable, but is built up sequentially to reduce power and area. An SRAM that can be read sequentially and/or written sequentially has drastically simplified logic and circuitry for reads and/or writes. An SRW memory can be used with or in an attention dot unit to supply weights to attention multiplier circuit 600. Attention multiplier circuit 600 may be a part of an ADU. In one implementation, the ADU having the attention multiplier circuit 600 may receive an input number and multiplies it by a number from SRAM (e.g., SRW memory) every clock cycle. 64 SRAMs can be used to store the 32 layers and K vs. V separately, so the SRAM can read lines sequentially.

According to one aspect, the SRW memory may be referred to as Key-Value Static Random-Access Memory (KV SRAM), which can store data in key-value pairs. KV SRAM can enable storing the attention history (e.g., cached keys and values) of a transformer block.

Referring back to FIG. 6, the models-on-silicon chip includes an attention dot unit (shown as attention multiplier) as illustrated by FIG. 6. The attention dot unit may receive an input number and multiplies it by a number from SRAM—every clock cycle. 64 SRAMs are used to store the 32 layers and K vs. V separately, so the SRAM can read lines sequentially.

In some embodiments, a models-on-silicon chip has a sequential read/write memory to store a key-value cache for the transformer-based neural network. To improve computational efficiency, one or more key-value caches can be included on chip with the ADUs to enhance the performance of the transformer-based neural network by temporarily storing frequently accessed data. Keys and values computed in the attention mechanism can be cached to allow for rapid retrieval of information. In the context of transformer-based neural networks, the key typically represents a unique identifier for a specific input or query, while the value contains the corresponding output or computational result. This caching mechanism deals with dynamic data, and thus uses read/write memory, such as SRAM. The key-value cache can significantly reduce latency and computational overhead by avoiding redundant calculations and data fetching, thereby improving the efficiency and responsiveness of the model during inference. Because the cached keys and values can be written and read sequentially during inference, the SRAM implementation can be simplified by restricting reads and writes to be done in a sequential manner (obviating circuits that allow for random-access).

Attention multiplier circuit 600 may have the following exemplary specification:

Attention Multiplier
Description
Receives an input number and multiplies it by a
number from SRAM - every clock cycle.
64 SRAMs are used to store the 32 layers and K vs.
V separately, so the SRAM can read lines sequentially.
Inputs

| | | |
|---|---|---|
| Q or KQ number | FP16 | 16b |
| K or V number | FP16 | 16b |
| K/V | Control | 1b |
| Layer | Control | 5b |
| Rd - SRAM read | Control | 1b |
| Wr - SRAM write | Control | 1b |
| L - SRAM line to write | Control | 5b |
| Store Q/QK | Control | 1b |
| On/Sleep | Control | 1b |

Outputs

| | | |
|---|---|---|
| Multiplication | Q16.16 | 32b |

Details
Based on the layer and if multiplying K or V,
the decoder 604 turns on one of the 64 SRAMs 602.
Number from SRAM read sequentially (line by line).
Since there are 16 ADUs per head, (only) 32 lines
are needed (out of up to 512 context).
Output is a 32-bit fixed-point so adders can use it.

| | |
|---|---|
| Instances | 65,536 (32 heads × 16 dot/head × 128) |

Attention multiplier circuit 600 may be included in an ADU to perform multiplication of two numbers (e.g., FP16 value and FP16 value), where one of the two numbers is read from the sequential read/write memory storing the key-value cache. As illustrated, attention multiplier circuit 600 includes 64 SRW memories 602, and decoder 604 may turn on one of the 64 SRW memories 602 to be used. Data is read from the active SRW memory serially, e.g., line by line. The data the active SRW memory is multiplied against the input by multiplier 606.

Many instances of attention multiplier circuit 600 may be included in an ADU to perform element-wise multiplication, e.g., in parallel. The multiplication results of the instances of attention multiplier circuit 600 can be summed by a tree adder to form a vector dot product result. The ADU may perform many vector dot products to form a final matrix multiplication result.

### Activator Circuits: Exponent Unit Circuit and Sigmoid Linear Unit Activator Circuit

In some embodiments, the models-on-silicon chip has one or more read-only memories to store one or more look up tables for approximating one or more functions, e.g., f(x). The look up tables can store precomputed values of a function, f(x). The precomputed values may correspond to one or more values or segments over a range of values of an input number, x. The input number, x, can be used as an index or address to look up and obtain a precomputed value, f(x), from the look up table. The precomputed values can be stored in a ROM. The functions that are a part of the transformer-based neural network are established ahead of time, and thus it is possible to construct look up tables with precomputed values. Compute calculations can be avoided during real-time inference, which saves power and reduces latency.

Examples of a function may include activation functions. Activation functions introduce non-linearity into the model, enabling it to learn complex patterns. An example of an activation function includes the RELU, which outputs the input directly if it is positive and zero otherwise, thus helping to mitigate the vanishing gradient problem. Another example of an activation function includes the SILU function, which maps input values to a range between 0 and 1, is often used in binary classification tasks. Another example of an activation function includes the Hyperbolic Tangent (Tanh) function, similar to SILU but with outputs ranging from −1 to 1, is useful for centering data. Another example of an activation function includes Leaky RELU, which allows a small gradient when the input is negative. Another example of an activation function includes the Swish function, defined as x·sigmoid(x), which has shown to improve model performance by providing smoother gradients and better convergence properties.

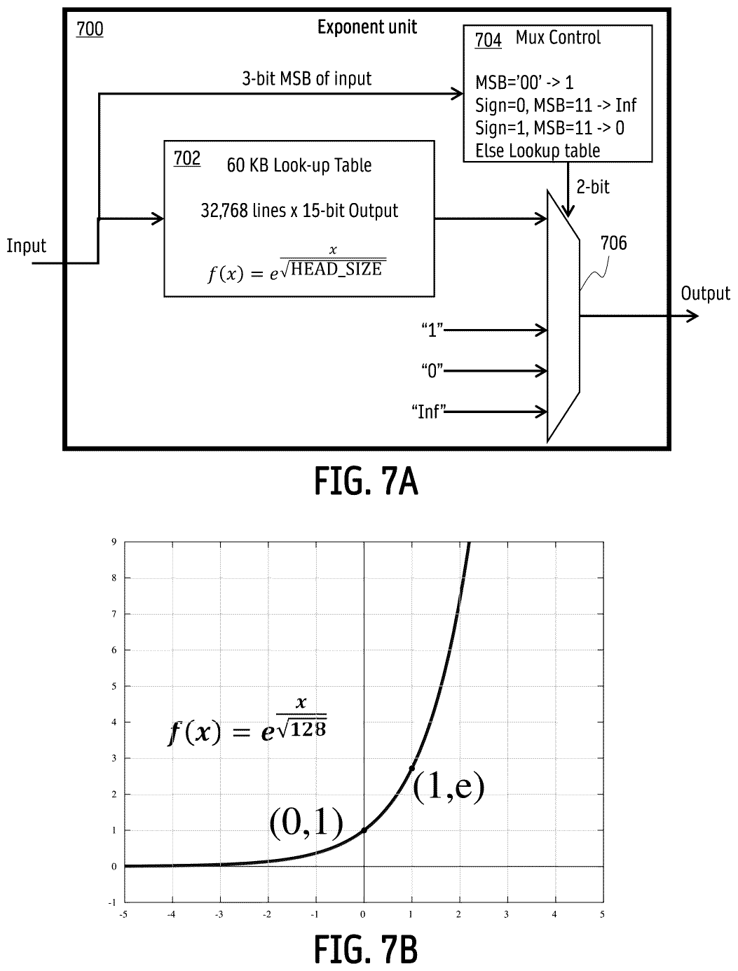

FIG. 7A illustrates exponent unit circuit 700, according to some embodiments of the disclosure. FIG. 7B illustrates an exponent function approximated by exponent unit circuit 700, according to some embodiments of the disclosure. Exponent unit circuit 700 includes a read-only memory to store a look up table 702 having one or more precomputed values of an exponent function:

$$f ( x ) = {e}^{\frac{x}{\sqrt{HEAD\_SIZE}}}$$

In some cases, exponent unit circuit 700 includes mux control 704 and mux 706. Mux control 704 may check whether the input value meets a particular condition, and selects a particular value to use as the output of exponent unit circuit 700. Mux control 704 may output a 2-bit value as selection signal for mux 706, to select one of four possible values to use as the output.

For example, if the most significant bits (MSBs) of the input are “00”, then the value of “1” is selected by mux 706 to use as the output. If the sign bit is 0 and the MSBs of the input are “11”, then the value of “Inf” (positive infinity) is selected by mux 706 to use as the output. If the sign bit is 1 and the MSBs of the input are “11”, then the value of “0” is selected by mux 706 to use as the output. Otherwise, the value from look up table 702 is used as the output.

FIG. 8A illustrates a SILU activator circuit 800, according to some embodiments of the disclosure. FIG. 8B illustrates a sigmoid linear unit function and a RELU function, according to some embodiments of the disclosure. SILU activator circuit 800 includes a read-only memory to store a look up table 802 having one or more precomputed values of a SILU function:

$$f ( x ) = \frac{x}{1 + {e}^{- x}}$$

In some cases, SILU activator circuit 800 includes mux control 804 and mux 806. Mux control 804 may check whether the input value meets a particular condition and selects a particular value to use as the output of SILU activator circuit 800. Mux control 804 may output a 2-bit value as selection signal for mux 806, to select one of three possible values to use as the output.

For example, if the sign bit is 0 and the MSBs of the input are “11”, then the input is selected by mux 806 and passed on to use as the output. If the sign bit is 1 and the MSBs of the input are “11”, then the value of “0” is selected by mux 806 to use as the output. Otherwise, the value from look up table 802 is used as the output.

### Weights Multiplier Circuit in Embedding Dot Unit Circuit

One operation of an inferencing task of a transformer-based neural network involves multiplying an embedding vector with a weight matrix. The embedding vector can represent a particular token, and various weight matrices of the transformer-based neural network are used to transform the embedding vector as the embedding vector progresses through the transformer-based neural network. The embedding vector is a vector representation of a token, and can be a dense, high-dimensional vector that encodes various types of information about the token, such as semantic information, syntactic information, contextual information, and positional information about the token. The weight matrix has weight values which have been learned through training to transform an embedding vector to extract patterns and relationships in the data.

Because the vector to matrix multiplication operation to be performed in models-on-silicon is known, the one or more circuits can include a custom-built embedding dot unit circuit that can perform the multiplication of the embedding vector with a weight matrix with low power. The custom-built embedding dot unit circuit can be designed to perform vector dot products. Multiplying an embedding vector having 1 by X elements with a weight matrix having X by Y elements involves calculating Y vector dot products and producing an output vector having Y elements (the output vector having the Y vector dot products). Each vector dot product is a dot product of the embedding vector with a column vector of the weight matrix (or a row vector of the weight matrix).

To calculate the vector dot product, element-wise multiplication of values in the embedding vector and values in a column/row vector of the weight matrix is performed, and the multiplication results are added together to form a value in the output vector. A number of multiplier circuits multiplying two floating-point numbers (e.g., an embedding value in the embedding vector and a weight value in the weight matrix) can be implemented to perform the element-wise multiplication of values for the vector dot product, e.g., in parallel. A tree adder circuit can be implemented to sum the multiplication results. Because the multiplication operation of an embedding value in the embedding vector with a weight value of the weight matrix is established ahead of time, a custom-built multiplier circuit to multiply the embedding value and the weight value may be implemented, such as a multiplier circuit that performs a specific task of FP8×FP6 multiplication (e.g., the embedding value may be an FP8 value, and the weight value may be an FP6 value).

According to one aspect, the models-on-silicon chip illustrated in FIGS. 1-4 has optimized physical layout and design. Matrix multiplications are predefined and known, and digital circuits, such as the EDU, can be designed and implemented to perform a specific type of matrix multiplication. Also, the format of the values being operated on are also predefined and known, so custom-built multiplier circuits can be designed and implemented to perform a specific type of multiplication of two values. For example, weights multiplier circuit 900 illustrated in FIG. 9 to be used in an EDU may be predefined and built with one specific task in mind (e.g., FP8×FP6 multiplication). In addition, at least SRO memory 904 is placed in proximity to multiplication circuit 908.

In some embodiments, the models-on-silicon chip includes weights multiplier circuit 900 (e.g., many instances of weights multiplier circuit 900). Weights multiplier circuit 900 can multiply an embedding value of an embedding vector of the transformer-based neural network and a weight value of a weight matrix of the transformer-based neural network. Weights multiplier circuit 900 may include multiplication circuit 908 to perform multiplication of an FP6 number (e.g., a weight value) and an FP8 number (an embedding value). Multiplication circuit 908 is designed with one specific task, to multiply an FP8 value and an FP6 value. The custom circuitry of multiplication circuit 908 means that the circuitry is simpler and consumes less power than other generic multiplication circuits.

Weights multiplier circuit 900 includes SRO memory 904 to store weights (e.g., weight values of a weight matrix). In some embodiments, weights multiplier circuit 900 may include SRAM 902. SRAM 902 may include a small read/write memory to store additional weight values that can be used in place of the etched weight values on SRO memory 904 (e.g., thus bypassing the etched weight values on SRO memory 904).

In some embodiments, SRAM 902 may store one or more weight values of a low-rank weight matrix. The transformer-based neural network may have pre-trained weights that are stored and etched in SRO memory 904. The transformer-based neural network may be fine-tuned using a Low-Rank Adaptation (LoRA) technique, where a low-rank weight matrix (a much smaller matrix than the original weight matrix) can be trained and updated so that the transformer-based neural network can perform a specific task. One or more tree adders 202 may add multiplication results produced by one or more multipliers 204 together.

In LoRA, the original weight matrix W can be decomposed into smaller low-rank matrices A and B, where ΔW=B·A. A low-rank weight matrix may be based on the original weight matrix W. A low-rank weight matrix may approximate the original weight matrix W. A low-rank weight matrix may capture significant features of the original weight matrix W while discarding less important features. A low-rank weight matrix may be a compressed version of the original weight matrix W. A low-rank weight matrix may have fewer linearly independent rows or columns when compared to the original weight matrix W. During fine-tuning, the weight values of the low-rank, smaller weights matrices A and B are updated, and not the weight values of the original weight matrix W. The weight values of the low-rank weight matrix can be stored in SRAM 902 to offer some flexibility for the models-on-silicon chip to implement a fine-tuned transformer-based neural network. In some implementations, a 2% LoRA update can be implemented to offer some flexibility. An application processor may write one or more weight values of the low-rank matrix onto SRAM 902.

In some embodiments, SRAM 902 may store one or more repair weight values. If there are one or more errors or faulty values in SRO memory 904 (the errors or faulty values can occur when values are being etched onto SRO memory 904), the errors or faulty values can be corrected by storing correct values, e.g., one or more repair weight values, in SRAM 902. The one or more repair weight values may correct one or more etched weight values.

Weights multiplier circuit 900 may include mux 906, SRAM 902, and SRO memory 904. Mux 906 can be used to select an output from SRAM 902 or an output from SRO memory 904 to be used as an input to multiplication circuit 908. Advantageously, mux 906 allows bypassing of a value read from SRO memory 904, and using the value from SRAM 902 to be used instead as the input to multiplication circuit 908. If selected by mux 906, multiplication circuit 908 may perform multiplication of a weight that is read from SRO memory 904. If selected by mux 906, multiplication circuit 908 may perform multiplication of a weight that is read from SRAM 902, such as a weight value of a low-rank weight matrix, or a repair weight value.

FIG. 10 illustrates embedding dot unit circuit 1000, according to some embodiments of the disclosure. According to one aspect, the models-on-silicon chip includes one or more instances of embedding dot unit circuit 1000. Embedding dot unit circuit 1000 can perform elements dot product operation between an embedding vector (e.g., FP8 embedding vector) and a weights vector (e.g., FP6 weights vector read from SRO memory) every cycle. Embedding dot unit circuit 1000 may include one or more instances (e.g., 4096 instances) of weights multiplier circuit 900. The instances of weights multiplier circuit 900 may perform multiplication in parallel. The outputs (e.g., 4096 outputs) may be added together by tree adder circuit 1002 of embedding dot unit circuit 1000. Embedding dot unit circuit 1000 may include tree adder circuit 1002 to add one or more multiplication results produced by one or more instances of weights multiplier circuit 900. In an implementation that adds 4096 numbers together, tree adder circuit 1002 may include 12 layers of adders and a total of 4095 adders. To sum all the multiplication results and receive a fused multiple add effect, tree adder circuit 1002 can implement a tree or hierarchical structure (and not a recursive structure) to add multiple input simultaneously and efficiently. In some embodiments, tree adder circuit 1002 uses a special fixed-point adder with a relatively large number of bits (e.g., 20 bits, 21 bits, . . . 32 bits), and uses a sampler 1004 to resample the final sum into a floating-point representation. Embedding dot unit circuit 1000 may generate an FP16 output. Using a large number of bits in tree adder circuit 1002 can prevent overflow during many stages/layers of adding.

### Power and Clock Gating

According to one aspect, the models-on-silicon chip can implement power/clock gating of one or more hardware components/blocks when not in use. In addition, using purpose-built SRO memories and SRW memories, it is possible to shut most of the memory off when only one line is needed for a given operation. In some cases, power and clock gating can be implemented by a sequencer circuit (e.g., flow control circuit 106 of FIGS. 1-2).

### Bit Cell Area Optimization

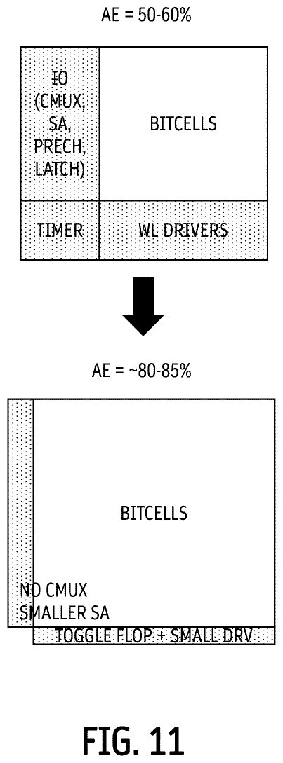

FIG. 11 illustrates bit cell area optimization, according to some embodiments of the disclosure. According to one aspect, the models-on-silicon chip illustrated in FIGS. 1-4 benefits from reduced bit cell area. Due to relaxed performance requirement and architecture enabled circuit optimization, the area of a bit cell in ROM can be reduced. The models-on-silicon chip has array efficiency (AE) between 80-85%, which may translate to 1.5× density gain.

### Custom Multiplier Circuits

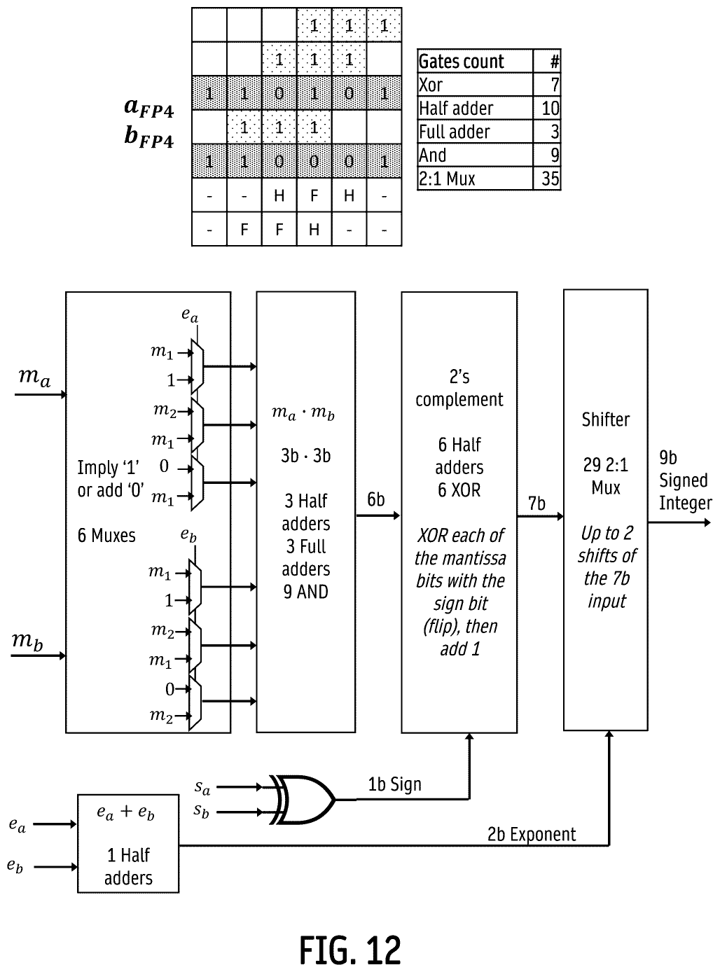

FIG. 12 illustrates a weights multiplier circuit, according to some embodiments of the disclosure. According to one aspect, a weights multiplier implements tailor made optimized hardware for specific floating-point multiplication. In contrast to the multiplication circuit 908 of FIG. 9, the logic shown in FIG. 12 implements multiplying a FP4 input by a FP8 input.

It is envisioned by the disclosure that various custom floating-point multiplication logic can be implemented for performing floating-point multiplication on the models-on-silicon chip (e.g., FP4×FP8, FP6×FP8, FP16×FP16, etc.).

### SoftMax Circuit

FIG. 13 illustrates SoftMax circuit 1300, according to some embodiments of the disclosure. According to one aspect, the models-on-silicon chip includes a hardware implementation of the SoftMax function, e.g.:

$$\frac{{e}^{\frac{{x}_{i} - {x}_{max}}{\sqrt{128}}}}{{\sum }_{j = 0}^{t} {e}^{\frac{{x}_{j} - {x}_{max}}{\sqrt{128}}}}$$

SoftMax circuit 1300 depicted in FIG. 13 includes look up table implementation of a SoftMax function and is not a compute-oriented solution. SoftMax circuit 1300 receives an input vector of t FP16 elements (1<t<512) and return the SoftMax normalized vector of the same size. SoftMax circuit 1300 receives 16 numbers per cycle for up to 32 cycles and returns 16 numbers per cycle for up to 32 cycles. SoftMax circuit 1300 can have the following exemplary specification:

SoftMax
Description
Receives an input vector of t FP16 elements
(1 < t < 512) and returns the SoftMax normalized
vector of the same size. Receives 16 numbers per
cycle for up to 32 cycles and returns 16 numbers
per cycle for up to 32 cycles.
Inputs

| | | |
|---|---|---|
| Input Vector | X16 FP16 | 256 |
| SoftMax compare | Control | 1b |
| SoftMax normalize | Control | 1b |
| SoftMax exponent | Control | 1b |
| SoftMax multiply | Control | 1b |
| SoftMax on/off | Control | 1b |

Outputs

| | | |
|---|---|---|
| SoftMax-ed Vector | x16 UFP16 | 240b |

Details
Unit receives x16 FP16 number every clock
cycle for 16 clock cycles.
Numbers are stored in a first-in-first-out (FIFO)
buffer, while they are compared to find the
largest number in the vector.
FIFO buffer outputs numbers, largest number
subtracted, exponent the result with a look
up table, and enter a further FIFO buffer.
Numbers are pulled out of the further FIFO
and multiplied by the normalization value.
Total output takes 24 cycles - 8 latency, 16 piping.

| | |
|---|---|
| Instances | 32 |

SoftMax circuit 1300 may be included in an ADU to perform SoftMax on an input vector (e.g., FP16 vector) and to output a SoftMax-ed vector (e.g., FP16 vector). SoftMax circuit 1300 may include ROM 1302 storing a look up table comprising one or more precomputed values of an exponent function:

$$f ( x ) = {e}^{\frac{x}{\sqrt{128}}} .$$

SoftMax circuit 1300 may include ROM 1304 storing a look up table comprising one or more precomputed values of a reciprocal function:

$$f ( x ) = \frac{1}{x} .$$

SoftMax circuit 1300 may include tree adder 1306 to add a number of values (e.g., 18 values) together simultaneously.

### Maximizing Floating-Point Range

According to one aspect, the models-on-silicon chip maximizes floating-point range. The chip may implement predefined floating-point tables and ranges that do not have Inf (infinity) nor NaN (not a number) numbers. The predefined tables and ranges can be used because the data into each module is controlled, which enables a non-overflow process, and enables maximizing the range of numbers.

### Embedder Circuit

FIG. 14 illustrates embedder circuit 1400, according to some embodiments of the disclosure. A models-on-silicon chip includes a hardware implementation to produce an embedding vector (e.g., 4096 FP16 elements) of the input token. Embedder circuit 1400 can return 256 elements every clock cycle for 16 clocks cycles. As depicted, embedder circuit 1400 may include a number of ROMs to store look up tables. The example shown includes 256 ROMs storing 256 look up tables. Embedder circuit 1400 can have the following exemplary specification:

Embedder
Description
Returns the embedding vector (4,096 FP16 elements) of the input token.
Returns 256 elements every clock for 16 clocks cycles.
Inputs

| | | |
|---|---|---|
| Token | 15b Integer | 15b |
| Embedder cycle | Control | 4b |
| Embedder run | Control | 1b |
| Embedder on/off | Control | 1b |

Outputs

| | | |
|---|---|---|
| Embedding Vector | x256 FP16 | 4,096b |

Details
Total embedder size is 250 MB − 4,096 × 32,000 × 2 B.
Embedder is divided into 256 1,000 KB look up
tables, each with 512,000 lines and FP16 output,
since each of the 32,000 tokens in the vocabulary
is broken into 16 chunks of 256 numbers.
For ROM implementation, once the first out of
16 numbers are read from the table, reading
from the ROM is sequential for 16 cycles,
so only the next line needs to be pre-charged.
After working for 16 cycles, the embedder unit
is asleep for about 10,000 cycles.
May use power gating.

| | |
|---|---|
| Instances | 1 |

### RMS Normalizer Circuit

FIG. 15 illustrates RMS normalizer circuit 1500, according to some embodiments of the disclosure. The models-on-silicon chip implements a hardware implementation of an RMS normalizer function:

$$\frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}}$$

RMS normalizer circuit 1500 can receive an input vector (e.g., 4096 FP16 elements) and return an RMS-normalized vector (e.g., 4096 elements in FP8 format). RMS normalizer circuit 1500 can receive 256 elements every clock for 16 clocks cycles. RMS normalizer circuit 1500 can have the following exemplary specification:

RMS Normalizer
Description
Receives an input vector of 4,096 FP16 elements
and return the RMS-normalized vector of 4,096
elements in FP8 format. Returns 256 elements
every clock for 16 clocks cycles.
Inputs

| | | |
|---|---|---|
| Input Vector | x256 FP16 | 4,096b |
| RMS run input | Control | 1b |
| RMS normalize | Control | 1b |
| RMS run output | Control | 1b |
| RMS on/off | Control | 1b |

Outputs

| | | |
|---|---|---|
| Normalized Vector | x256 FP8 | 2,048b |

Details
Unit receives x256 FP16 number every clock
cycle for 16 clock cycles.
Numbers are stored in FIFO buffer, and in parallel
they are squared and summed - 4 cycles latency.
After all numbers have been summed, a look up table
returns the normalization value - 1 cycle latency.
Numbers are pulled out of the FIFO bufferand multiplied
by the normalization value, then multiplied by weight
from ROM, then sampled FP8.
Total output takes 24 cycles - 8 latency, 16 piping.

| | |
|---|---|
| Instances | 1 |

RMS normalizer circuit 1500 may include tree adder 1502 to add a number of values (e.g., 256 values) together simultaneously. RMS normalizer circuit 1500 may include ROM 1504 storing a look up table comprising one or more precomputed values of the function:

$$f ( x ) = {\sqrt{\frac{x}{4 , 096} + {10}^{- 5}}}^{- 1} .$$

### Sampler Circuit

FIG. 16 illustrates sampler circuit 1600, according to some embodiments of the disclosure. FIG. 17 illustrates sampling comparator circuit 1602 that can be implemented in sampler circuit 1600, according to some embodiments of the disclosure. According to one aspect, the models-on-silicon chip implements a hardware implementation of a sampler to return a token (e.g., an index, such as a 32-bit index) corresponding to the largest number in an input vector (e.g., 32,000 elements input vector having logits). Sampler circuit 1600 may implement a deterministic sampler having zero temperature. Sampler circuit 1600 may have the following exemplary specification:

Sampler
Description
Returns the token (32-bit index) of the largest
number in the 32,000 elements input vector.
This is a hardware implementation of a
deterministic Sampler (Zero temperature).
Inputs

| | | |
|---|---|---|
| Logits vector | x256 FP16 | 4,096b |
| Sampler on/off | Control | 1b |
| Sampler restart | Control | 1b |
| Sampler run | Control | 1b |

Outputs

| | | |
|---|---|---|
| Output token | 15b Integer | 15b |

Details
For 125 clock cycles (time it takes to calculate Wcls),
256 FP16 numbers are received from the 256 matrix
multiplication (e.g., vector dot product) circuits.
For best performance, Sampler may to compare the 256
incoming FP16 numbers every clock cycle and keep the
index and value of the largest number.
If more then one number has the largest value,
Sampler returns the token with the lowest index
out of the equal tokens.
Latency is 9 clock cycles - Every layer of comparators is pipelined.
May include power gating for this unit.

| | |
|---|---|
| Instances | 1 |

Sampling comparator circuit 1602 may have the following exemplary specification:

Sampling Comparator
Description
Compares two FP16 numbers (logits) and returns
the larger number and its index (token).
Inputs

| | | |
|---|---|---|
| Value A | FP16 | 16b |
| Index A (Token) | 15b Integer | 15b |
| Value B | FP16 | 16b |
| Index B (Token) | 15b Integer | 15b |

Outputs

| | | |
|---|---|---|
| Larger Value | FP16 | 16b |
| Larger value's index | 15b Integer | 15b |

Details
Output in ready in a single clock cycle.
Flopped.

| | |
|---|---|
| Instances | 256 |

The models-on-silicon chip may include sampler circuit 1600 to return a token of the largest number in an input vector (e.g., the index in the input vector corresponding to the largest value the input vector).

In some embodiments, sampler circuit 1600 includes a tree comparator circuit having many layers of instances of sampling comparator circuit 1602 arranged in a tree structure or hierarchical structure to efficiently compare a large number of values (e.g., hundreds or thousands of values or more) simultaneously.

### Rotary Embedder Circuit

FIG. 18A illustrates a rotary positional encoding (RoPE) circuit 1800, according to some embodiments of the disclosure. FIG. 18B illustrates a cosine function and a sine function, according to some embodiments of the disclosure. The models-on-silicon chip implements a hardware implementation of a rotary positional encoder to produce rotary positional encoded embeddings. Circuit 1800 is implemented to provide the functionality of a sine cosine unit without the need to calculate/compute sine and cosine in real-time. The sine cosine unit has a look up table implementation. Rotary positional encoding circuit 1800 may include ROM 1802 to store a look up table comprising one or more precomputed values of a cosine function

$$( e . g . , f ( t ) = cos ( {10}^{- \frac{{h}_{n}}{16}} \cdot t ) ) .$$

Rotary positional encoding circuit 1800 may include ROM 1804 to store a look up table comprising one or more precomputed values of sine function

$$( e . g . , f ( t ) = sin ( {10}^{- \frac{{h}_{n}}{16}} \cdot t ) ) .$$

### Scaling the Models-On-Silicon Architecture

In some embodiments, an apparatus can include a processing circuit implementing an application (e.g., a user application), and can receive input data and generate one or more input tokens. The apparatus can further include an inferencing circuit, such as a models-on-silicon chip as described herein. The inferencing circuit can receive the one or more input tokens and output one or more output tokens. In some embodiments, the processing circuit receives one or more output tokens generated by the inferencing circuit.

The models-on-silicon architecture is modular and can be scaled to implement larger transformer-based neural networks.

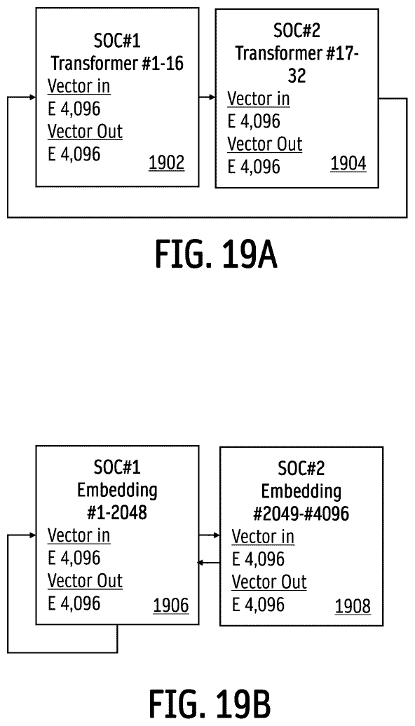

FIG. 19A illustrates using multiple chips to implement a large transformer model, according to some embodiments of the disclosure. FIG. 19B illustrates using multiple chips to implement a large transformer model, according to some embodiments of the disclosure. According to one aspect, models-on-silicon architecture enables scaling through multi-chip implementation. To implement huge models such as models with more than 1 trillion parameters, multiple instances of the models-on-silicon chips can be arranged together in the various manners illustrated in FIGS. 19A-B. For example, transformer output of 4096 vectors of one chip can be passed using a general purposes input/output (GPIO) output to another chip, and so on. Many chips can be coupled together to form a larger transformer model architecture and scale as needed.

Referring to FIG. 19A, multiple models-on-silicon chips can be stacked, where chip 1902 may embed one subset of transformers, e.g., transformers 1-16, of a transformer-based neural network, and chip 1904 can embed a further subset of transformers, e.g., transforms 17-32, of the transformer-based neural network. Chip 1904 (e.g., a further inferencing circuit) can receive the one or more output tokens from chip 1902 (e.g., the inferencing circuit) and output one or more further output tokens. The one or more further output tokens can be fed back as input to chip 1902 in an auto-regressive manner.

Referring to FIG. 19B, multiple models-on-silicon chips can be parallelized (e.g., implementing tensor parallelism), where chip 1906 may perform processing of a subset of embedding values, e.g., embedding values 1-2048, of embedding vector having 4096 elements, and chip 1908 may perform processing of a further subset of embedding values, e.g., embedding values 2049-4096, of embedding vector having 4096 elements.

### Hardware-Based Inferencing Process

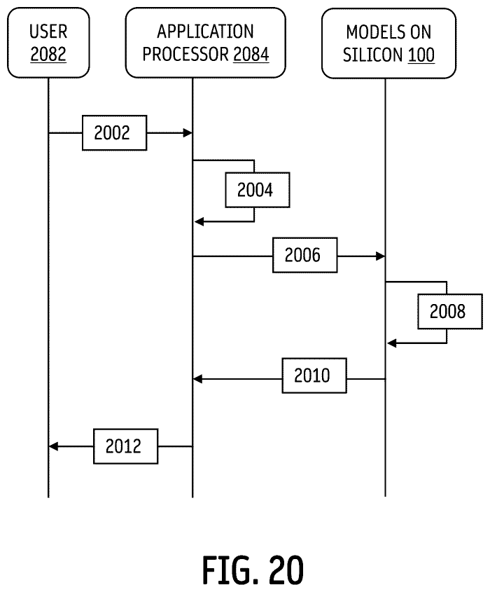

FIG. 20 illustrates hardware-based inferencing process with embedded LLM model and ROM, according to some embodiments of the disclosure. According to one aspect, the process of using the models-on-silicon chip to implement a model such as a transformer model is different from the traditional inferencing process involving a GPU.

The process of using the models-on-silicon chip 100 begins in 2002 with user 2082 providing input data for inferencing. User 2082 may provide input data to application processor 2084 (sometimes referred to as a host processor) implementing a user application.

In 2004, application processor 2084 may tokenize the input data and transform the input data into tokenized embeddings.

In 2006, the tokenized embeddings are passed onto models-on-silicon chip 100. In some embodiments, the input data as one or more tokens can be loaded into models-on-silicon chip 100 as a vector of tokens, or a vector of token embeddings.

Unlike traditional setups using GPUs, the model and its weights are already embedded in the ROM of application processor 2084. The step of loading models or weights from external sources is eliminated.

In 2008, the models-on-silicon chip 100 performs inference and executes a transformer-based neural network. The tokenized embeddings, along with the weights of the model, are read directly from the embedded ROM (e.g., SRO memory). This means that the information used for the inferencing process is available on models-on-silicon chip 100 itself, leading to faster data retrieval and processing. The information is retrieved from the ROM, it is moved to one or more circuits for processing and execution. The one or more circuits are coupled to form a feedforward network within models-on-silicon chip 100. The feedforward network handles the inferencing computations and operations and is orchestrated by a sequencer circuit to perform operations according to a timing sequence to generate one or more output tokens. The models-on-silicon chip 100 computes the output token. If a next output token is to be generated, the output token can be fed back to models-on-silicon chip 100 as an input to generate a next output token in an auto-regressive manner.

In 2010, after processing, one or more output tokens are directed back to the application processor 2084.

Notably, the input and output interfaces of models-on-silicon (interfacing with application processor 2084) are very low bandwidth interfaces. Since the (entire) inference model architecture and weights are embedded in the SoC, the only data being input and output are tokens. Usually, each token is the size of 2 Bytes (based on the vocabulary size).

In 2012, the application processor 2084 may process the one or more output tokens and generate user output representing the inferencing result back to user 2082.

This approach of embedding the model and its weights in the hardware models-on-silicon chip 100 significantly streamlines the inferencing process, reducing latency and increasing efficiency, as it eliminates the need for external memory and data transfer. By hardcoding or etching the weights and model onto models-on-silicon chip 100 itself, it eliminates the need to load these weights from random-access memory for each task, thereby reducing power consumption and improving processing speed. The design of models-on-silicon chip 100 enables it to handle the complex calculations for machine learning inferencing tasks in real-time applications.

### Enhanced Matrix Multiplication Operations

In some embodiments, the models-on-silicon chip 100 implements Embedded Weights and models Fused Multiply-Add Architecture (EWFMAA) to perform matrix multiplication operations. This architecture can be designed specifically to perform Fused Multiply-Add (FMA) operations with embedded weights and models, significantly enhancing the efficiency of matrix operations in machine learning tasks.

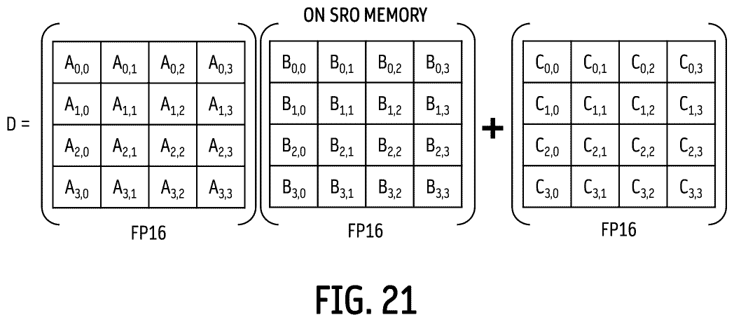

The solution may implement a series of cores, each providing a matrix processing array which performs the operation D=A*B+C, where A, B, C and D are FP16 matrices. The operation is illustrated in FIG. 21. A feature of this architecture is that the weight matrix B is hardcoded directly onto the chip, eliminating the need to load these weights from external random-access memory for each inference task.

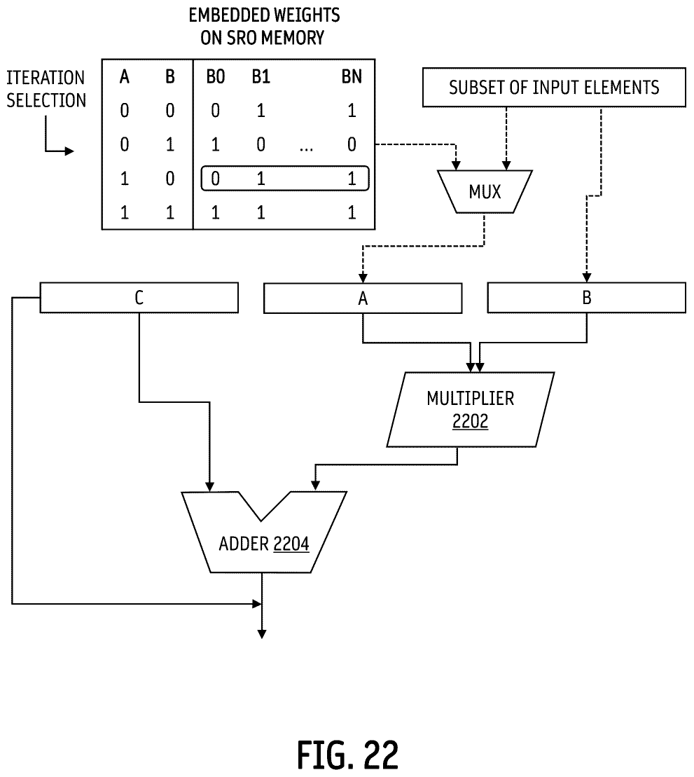

Exemplary logic for implementing EWFMAA is illustrated in FIG. 22. The flow of operations within the EWFMAA is as follows: (1) the hardcoded weights are retrieved, (2) the input data matrix A & B for the inference task are loaded, (3) each core having multiplier 2202 and adder 2204 performs the FMA operation D=A*B+C, where D is FP16 matrix, and C is an accumulator, (4) process continues until the dot operation is complete.

The architecture with its embedded weights, model and optimized transformer operations such as FMA operations, normalization, activation and SoftMax provides a highly efficient and powerful solution for inference tasks. It significantly reduces power consumption and enhances processing speed, making it ideal for applications demanding real-time inference and low power consumption.

### Exemplary Use Cases

Data Centers: The chip can be used in data centers for tasks that require inference. With a reduction in power consumption and increase in speed.

Edge Computing and Mobile: The chip can be used in edge computing devices, which require low power consumption and fast processing times. This could include anything from IoT devices to mobile phones.

Autonomous Vehicles: The chip can be used in autonomous vehicles to quickly and efficiently make real-time decisions. The speed is particularly advantageous in this scenario.

Medical Devices: The chip can be used in medical devices that require real-time inference, such as diagnostic devices or monitoring equipment. The low power consumption and fast processing times are crucial in these applications.

Security applications: The chip can be used in security applications where speed, reliability and security are crucial. These could include surveillance systems, autonomous drones, or equipment for data analysis and threat detection, as the model and weights are hardcoded into the hardware, model integrity is assured and less susceptible to manipulation.

### Method for Performing Inference

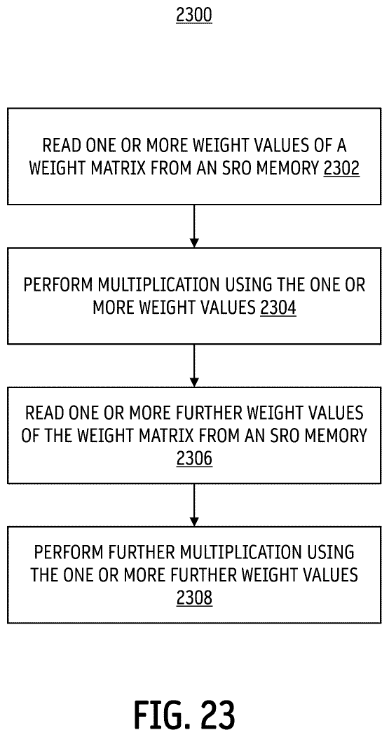

FIG. 23 is a flow diagram illustrating method 2300 for performing inference on a models-on-silicon chip, according to some embodiments of the disclosure. Method 2300 may be carried out by models-on-silicon chip as described herein.

In 2302, a circuit of a models-on-silicon chip may read one or more weight values of a weight matrix of a transformer-based neural network from a sequential read-only memory of the models-on-silicon chip.

In 2304, the circuit may perform multiplication using the one or more weight values. For instance, the circuit may perform element-wise multiplication of the one or more weight values of a weight vector with one or more embedding values of an embedding vector. The multiplication results may be summed by a tree adder to produce a dot product of the embedding vector and the weight vector.

In 2306, the circuit of the models-on-silicon chip may read one or more further weight values of the weight matrix of the transformer-based neural network from the sequential read-only memory of the models-on-silicon chip.

In 2308, the circuit may perform further multiplication using the one or more further weight values. For instance, the circuit may perform element-wise multiplication of the one or more further weight values of a further weight vector with the one or more embedding values of the embedding vector. The multiplication results may be summed by a tree adder to produce a dot product of the embedding vector (or the further embedding vector) and the further weight vector. In another instance, the circuit may perform element-wise multiplication of the one or more further weight values of a further weight vector with one or more further embedding values of a further embedding vector. The multiplication results may be summed by a tree adder to produce a dot product of the further embedding vector and the further weight vector.

In some embodiments, method 2300 may further include orchestrating the multiplication and the further multiplication to be performed by the circuit according to a predetermined a timing sequence. The multiplication may be performed during a cycle, and the further multiplication may be performed during a next cycle.

In some embodiments, method 2300 may further include a yet further circuit of the models-on-silicon-chip reading a cached key or a cached value from a sequential read/write memory. Method 2300 may further include the yet further circuit performing a yet further multiplication using the cached key or the cached value.

### Exemplary Computing Device

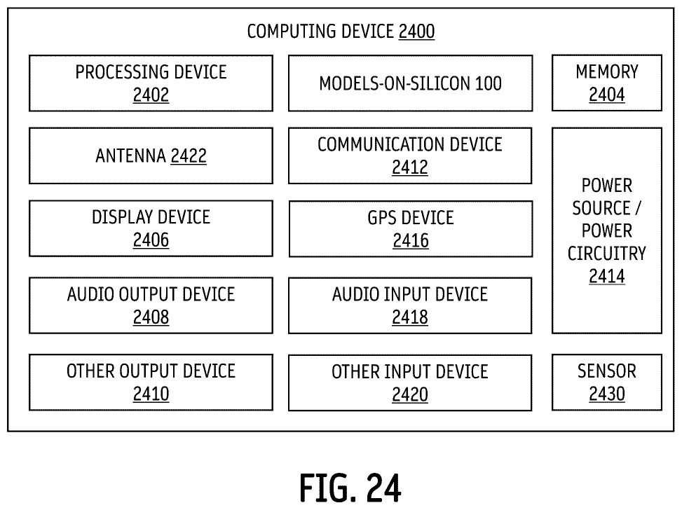

FIG. 24 is a block diagram of an apparatus or a system, e.g., an exemplary computing device 2400, according to some embodiments of the disclosure. One or more computing devices 2400 may be used to implement the functionalities described with the FIGS. and herein. A number of components are illustrated in the FIGS. can be included in the computing device 2400, but any one or more of these components may be omitted or duplicated, as suitable for the application. In some embodiments, some or all of the components included in the computing device 2400 may be attached to one or more motherboards. In some embodiments, some or all of these components are fabricated onto a single SoC die. Additionally, in various embodiments, the computing device 2400 may not include one or more of the components illustrated in FIG. 24, and the computing device 2400 may include interface circuitry for coupling to the one or more components. For example, the computing device 2400 may not include a display device 2406, and may include display device interface circuitry (e.g., a connector and driver circuitry) to which a display device 2406 may be coupled. In another set of examples, the computing device 2400 may not include an audio input device 2418 or an audio output device 2408 and may include audio input or output device interface circuitry (e.g., connectors and supporting circuitry) to which an audio input device 2418 or audio output device 2408 may be coupled.

The computing device 2400 may include a processing device 2402 (e.g., one or more processing devices, one or more of the same types of processing device, one or more of different types of processing device). The processing device 2402 may include electronic circuitry that process electronic data from data storage elements (e.g., registers, memory, resistors, capacitors, quantum bit cells) to transform that electronic data into other electronic data that may be stored in registers and/or memory. Examples of processing device 2402 may include a CPU, a GPU, a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a FPGA, a TPU, a data processing unit (DPU), etc.

In some embodiments, the computing device 2400 may include models-on-silicon chip 100 as described herein. Models-on-silicon chip 100 can interface with processing device 2402 to accelerate inference.

The computing device 2400 may include a memory 2404, which may itself include one or more memory devices such as volatile memory (e.g., DRAM), nonvolatile memory (e.g., ROM), HBM, flash memory, solid state memory, and/or a hard drive. Memory 2404 includes one or more non-transitory computer-readable storage media. In some embodiments, memory 2404 may include memory that shares a die with the processing device 2402.

In some embodiments, memory 2404 includes one or more non-transitory computer-readable media storing instructions executable to perform operations described with the FIGS. and herein. Memory 2404 may store instructions that generate inputs to models-on-silicon chip 100. Memory 2404 may store instructions that process outputs from models-on-silicon chip 100. The instructions stored in the one or more non-transitory computer-readable media may be executed by processing device 2402.

In some embodiments, memory 2404 may store data, e.g., data structures, binary data, bits, metadata, files, blobs, etc., as described with the FIGS. and herein. Data may include inputs to models-on-silicon chip 100. Data may include outputs from models-on-silicon chip 100.

In some embodiments, the computing device 2400 may include a communication device 2412 (e.g., one or more communication devices). For example, the communication device 2412 may be configured for managing wired and/or wireless communications for the transfer of data to and from the computing device 2400. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 2412 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 2412 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication device 2412 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 2412 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 2412 may operate in accordance with other wireless protocols in other embodiments. The computing device 2400 may include an antenna 2422 to facilitate wireless communications and/or to receive other wireless communications (such as radio frequency transmissions). The computing device 2400 may include receiver circuits and/or transmitter circuits. In some embodiments, the communication device 2412 may manage wired communications, such as electrical, optical, or any other suitable communication protocols (e.g., the Ethernet). As noted above, the communication device 2412 may include multiple communication chips. For instance, a first communication device 2412 may be dedicated to shorter-range wireless communications such as Wi-Fi or Bluetooth, and a second communication device 2412 may be dedicated to longer-range wireless communications such as global positioning system (GPS), EDGE, GPRS, CDMA, WiMAX, LTE, EV-DO, or others. In some embodiments, a first communication device 2412 may be dedicated to wireless communications, and a second communication device 2412 may be dedicated to wired communications.

The computing device 2400 may include power source/power circuitry 2414. The power source/power circuitry 2414 may include one or more energy storage devices (e.g., batteries or capacitors) and/or circuitry for coupling components of the computing device 2400 to an energy source separate from the computing device 2400 (e.g., DC power, AC power, etc.).

The computing device 2400 may include a display device 2406 (or corresponding interface circuitry, as discussed above). The display device 2406 may include any visual indicators, such as a heads-up display, a computer monitor, a projector, a touchscreen display, a liquid crystal display (LCD), a light-emitting diode display, or a flat panel display, for example.

The computing device 2400 may include an audio output device 2408 (or corresponding interface circuitry, as discussed above). The audio output device 2408 may include any device that generates an audible indicator, such as speakers, headsets, or earbuds, for example.

The computing device 2400 may include an audio input device 2418 (or corresponding interface circuitry, as discussed above). The audio input device 2418 may include any device that generates a signal representative of a sound, such as microphones, microphone arrays, or digital instruments (e.g., instruments having a musical instrument digital interface (MIDI) output).

The computing device 2400 may include a GPS device 2416 (or corresponding interface circuitry, as discussed above). The GPS device 2416 may be in communication with a satellite-based system and may receive a location of the computing device 2400, as known in the art.

The computing device 2400 may include a sensor 2430 (or one or more sensors). The computing device 2400 may include corresponding interface circuitry, as discussed above). Sensor 2430 may sense physical phenomenon and translate the physical phenomenon into electrical signals that can be processed by, e.g., processing device 2402. Examples of sensor 2430 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 2400 may include another output device 2410 (or corresponding interface circuitry, as discussed above). Examples of the other output device 2410 may include an audio codec, a video codec, a printer, a wired or wireless transmitter for providing information to other devices, haptic output device, gas output device, vibrational output device, lighting output device, home automation controller, or an additional storage device.

The computing device 2400 may include another input device 2420 (or corresponding interface circuitry, as discussed above). Examples of the other input device 2420 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2400 may have any desired form factor, such as a handheld or mobile computer system (e.g., a cell phone, a smart phone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an IoT device, or a wearable computer system. In some embodiments, the computing device 2400 may be any other electronic device that processes data.

### Select Examples

Example 1 provides an integrated circuit, including a sequential read-only memory to store one or more weight values of a weight matrix of a transformer-based neural network; one or more circuits to perform one or more operations of an inferencing task of the transformer-based neural network; and a sequencer to orchestrate the one or more circuits according to a predetermined timing sequence of the transformer-based neural network.

Example 2 provides the integrated circuit of example 1, further including a memory to store a key-value cache for the transformer-based neural network.

Example 3 provides the integrated circuit of example 2, where the memory is a sequential read/write memory.

Example 4 provides the integrated circuit of any one of examples 1-3, where the sequencer controls data flow into and/or out of the one or more circuits according to the predetermined timing sequence of the transformer-based neural network.

Example 5 provides the integrated circuit of any one of examples 1-4, where the sequential read-only memory powers up an active word line and a next active word line during a time slot in the predetermined timing sequence of the transformer-based neural network.

Example 6 provides the integrated circuit of example 5, where: the active word line has data that is processed by a circuit in the one or more circuits to perform an operation during the time slot; and the next active word line has data that is processed by the circuit to perform a further operation during a further time slot in the predetermined timing sequence of the transformer-based neural network.

Example 7 provides the integrated circuit of any one of examples 1-6, where the one or more circuits include a read-only memory to store a look up table having one or more precomputed values of an exponent function.

Example 8 provides the integrated circuit of any one of examples 1-7, where the one or more circuits include a read-only memory to store a look up table having one or more precomputed values of a sigmoid linear unit function.

Example 9 provides the integrated circuit of any one of examples 1-8, where the one or more circuits include a multiplier circuit to multiply an embedding value of an embedding vector representing a token of the transformer-based neural network and a weight value of a weight matrix of the transformer-based neural network.

Example 10 provides the integrated circuit of example 9, where the embedding value is an 8-bit floating-point number, and the weight value is a 6-bit floating-point number.

Example 11 provides the integrated circuit of example 9 or 10, where the weight value being multiplied by the multiplier circuit is read from the sequential read-only memory.

Example 12 provides the integrated circuit of example 9 or 10, further including a read-write memory to store one or more weights of a low-rank weight matrix, the low-rank weight matrix is an approximation of the weight matrix; and the weight value being multiplied by the multiplier circuit is read from the read-write memory.

Example 13 provides the integrated circuit of example 9 or 10, further including a read-write memory to store one or more repair weight values, the one or more repair weight values to replace one or more weight values of the weight matrix; and the weight value being multiplied by the multiplier circuit is read from the read-write memory.

Example 14 provides the integrated circuit of any one of examples 1-13, where the one or more circuits include an embedding dot unit circuit including a tree adder to add one or more multiplication results produced by one or more multiplier circuits multiplying two floating-point numbers.

Example 15 provides the integrated circuit of any one of examples 1-14, where the one or more circuits include a SoftMax circuit, the SoftMax circuit including a read-only memory to store a look up table including one or more precomputed values of an exponent function.

Example 16 provides the integrated circuit of any one of examples 1-15, where the one or more circuits include a SoftMax circuit, the SoftMax circuit including a read-only memory to store a look up table including one or more precomputed values of a reciprocal function.

Example 17 provides the integrated circuit of any one of examples 1-16, where the one or more circuits include a rotary positional encoding embedder circuit, the rotary positional encoding embedder circuit including a read-only memory to store a look up table including one or more precomputed values of a cosine function and/or a sine function.

Example 18 provides the integrated circuit of any one of examples 1-17, where the one or more circuits include a root mean square normalizer circuit, the root mean square normalizer circuit including a tree adder.

Example 19 provides the integrated circuit of any one of examples 1-18, where the one or more circuits include a sampler circuit to return a token corresponding to a largest value in an input vector, the sampler circuit including a tree comparator circuit.

Example 20 provides an apparatus, including a processing circuit to receive input data and generating one or more input tokens; and an inferencing circuit to receive the one or more input tokens and output one or more output tokens, the inferencing circuit including a sequential read-only memory to store one or more weight values of a weight matrix of a transformer-based neural network.

Example 21 provides the apparatus of example 20, where the processing circuit receives the one or more output tokens.

Example 22 provides the apparatus of example 20 or 21, further including a further inferencing circuit to receive the one or more output tokens from the inferencing circuit and output one or more further output tokens, the further inferencing circuit including a further sequential read-only memory to store one or more further weight values of a further weight matrix of a further transformer-based neural network.

Example 23 provides the apparatus of any one of examples 20-22, where the inferencing circuit includes one or more circuits to perform one or more operations of an inferencing task of the transformer-based neural network.

Example 24 provides the apparatus of example 23, further including a sequencer to orchestrate the one or more circuits of the inferencing circuit according to a predetermined timing sequence of the transformer-based neural network.

Example 25 provides a method, including reading one or more weight values of a weight matrix of a transformer-based neural network from a sequential read-only memory; performing multiplication using the one or more weight values; reading one or more further weight values of the weight matrix of the transformer-based neural network from the sequential read-only memory; and performing further multiplication using the one or more further weight values.

Example 26 provides the method of example 25, further including orchestrating the multiplication and the further multiplication to be performed according to a predetermined timing sequence.

Example 27 provides the method of example 25 or 26, further including reading a cached key or a cached value from a sequential read/write memory; and performing a yet further multiplication using the cached key or the cached value.

Example A is an apparatus comprising means for performing any one of the methods in examples 25-27 and method 2300 illustrated in FIG. 23.

### Variations and Other Notes

Although the operations of the example method shown in and described with reference to some of the FIGS. are illustrated as occurring once each and in a particular order, it will be recognized that the operations may be performed in any suitable order and repeated as desired. Additionally, one or more operations may be performed in parallel. Furthermore, the operations illustrated in some of the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An integrated circuit, comprising:
a sequential read-only memory to store one or more weight values of a weight matrix of a transformer-based neural network;
one or more circuits to perform one or more operations of an inferencing task of the transformer-based neural network; and
a sequencer to orchestrate the one or more circuits according to a predetermined timing sequence of the transformer-based neural network.

2. The integrated circuit of claim 1, further comprising:
a memory to store a key-value cache for the transformer-based neural network.

3. The integrated circuit of claim 2, wherein the memory is a sequential read/write memory.

4. The integrated circuit of claim 1, wherein the sequencer controls data flow into and/or out of the one or more circuits according to the predetermined timing sequence of the transformer-based neural network.

5. The integrated circuit of claim 1, wherein the sequential read-only memory powers up an active word line and a next active word line during a time slot in the predetermined timing sequence of the transformer-based neural network.

6. The integrated circuit of claim 5, wherein:
the active word line has data that is processed by a circuit in the one or more circuits to perform an operation during the time slot; and
the next active word line has data that is processed by the circuit to perform a further operation during a further time slot in the predetermined timing sequence of the transformer-based neural network.

7. The integrated circuit of claim 1, wherein the one or more circuits comprise:
a read-only memory to store a look up table having one or more precomputed values of an exponent function.

8. The integrated circuit of claim 1, wherein the one or more circuits comprise:
a read-only memory to store a look up table having one or more precomputed values of a sigmoid linear unit function.

9. The integrated circuit of claim 1, wherein the one or more circuits comprise:
a multiplier circuit to multiply an embedding value of an embedding vector representing a token of the transformer-based neural network and a weight value of a weight matrix of the transformer-based neural network.

10. The integrated circuit of claim 9, wherein the embedding value is an 8-bit floating-point number, and the weight value is a 6-bit floating-point number.

11. The integrated circuit of claim 9, wherein the weight value being multiplied by the multiplier circuit is read from the sequential read-only memory.

12. The integrated circuit of claim 9, further comprising:
a read-write memory to store one or more weights of a low-rank weight matrix, the low-rank weight matrix is an approximation of the weight matrix; and
the weight value being multiplied by the multiplier circuit is read from the read-write memory.

13. The integrated circuit of claim 9, further comprising:
a read-write memory to store one or more repair weight values, the one or more repair weight values to replace one or more weight values of the weight matrix; and
the weight value being multiplied by the multiplier circuit is read from the read-write memory.

14. The integrated circuit of claim 1, wherein the one or more circuits comprise:
an embedding dot unit circuit comprising a tree adder to add one or more multiplication results produced by one or more multiplier circuits multiplying two floating-point numbers.

15. The integrated circuit of claim 1, wherein the one or more circuits comprise a SoftMax circuit, the SoftMax circuit comprising one or more of:
a read-only memory to store a look up table comprising one or more precomputed values of an exponent function; and
a further read-only memory to store a look up table comprising one or more precomputed values of a reciprocal function.

16. The integrated circuit of claim 1, wherein the one or more circuits comprise a root mean square normalizer circuit, the root mean square normalizer circuit comprising a tree adder.

17. An apparatus, comprising:
a processing circuit to receive input data and generating one or more input tokens; and
an inferencing circuit to receive the one or more input tokens and output one or more output tokens, the inferencing circuit comprising a sequential read-only memory to store one or more weight values of a weight matrix of a transformer-based neural network.

18. The apparatus of claim 17, wherein the processing circuit receives the one or more output tokens.

19. A method, comprising:
reading one or more weight values of a weight matrix of a transformer-based neural network from a sequential read-only memory;
performing multiplication using the one or more weight values;
reading one or more further weight values of the weight matrix of the transformer-based neural network from the sequential read-only memory; and
performing further multiplication using the one or more further weight values.

20. The method of claim 19, further comprising:
orchestrating the multiplication and the further multiplication to be performed according to a predetermined timing sequence.
